(19) United States
(12) Patent Application Publication
(10) Pub. No.: US 2026/0056013 A1
(43) Pub. Date: Feb. 26, 2026

(54) THREE-DIMENSIONAL MEASUREMENT DEVICE, THREE-DIMENSIONAL MEASUREMENT METHOD, AND STORAGE MEDIUM STORING THREE-DIMENSIONAL MEASUREMENT PROGRAM

(71) Applicant: Keyence Corporation, Osaka (JP)

(72) Inventor: Shunsuke IGARASHI, Osaka (JP)

(73) Assignee: Keyence Corporation, Osaka (JP)

(21) Appl. No.: 19/254,062

(22) Filed: Jun. 30, 2025

(30) Foreign Application Priority Data
Aug. 22, 2024 (JP) 2024-140721

(51) Int. Cl. G01B 11/25; G01B 11/00; G06T 7/50

(52) U.S. Cl. CPC G01B 11/2518; G01B 11/002; G06T 7/50; G06T 2207/10028

(57) ABSTRACT

It is easy for a user to grasp whether necessary three-dimensional data has been acquired when three-dimensional data is acquired by a three-dimensional scanner. A three-dimensional coordinate generation unit sequentially generates three-dimensional coordinates of a measurement workpiece based on an image including pattern light generated by a scanner imaging part. A display control part sequentially generates display data in which the three-dimensional coordinates of the measurement workpiece sequentially generated by the three-dimensional coordinate generation unit are superimposed on a three-dimensional shape based on referred three-dimensional shape data registered by a registration unit. A three-dimensional data generation unit generates three-dimensional shape data of the measurement workpiece based on the three-dimensional coordinates of the measurement workpiece. A measurement unit performs measurement based on a referred measurement element registered by the registration unit and the three-dimensional shape data of the measurement workpiece.

The present application claims foreign priority based on Japanese Patent Application No. 2024-140721, filed August 22, 2024, the contents of which are incorporated herein by reference.

### BACKGROUND OF THE INVENTION

### 1. TECHNICAL FIELD

The disclosure relates to a three-dimensional measurement device for measuring a three-dimensional shape of a workpiece, a three-dimensional measurement method, and a storage medium storing a three-dimensional measurement program.

### 2. DESCRIPTION OF THE RELATED ART

For example, JP 2016-194896 A discloses, as a method of inspecting an inspection target, a method of acquiring three-dimensional scan data indicating a shape of the inspection target using a three-dimensional scanner, aligning CAD data and the three-dimensional scan data with the same coordinates, and then comparing an inspection element of the CAD data with an inspection element of the three-dimensional scan data.

However, in JP 2016-194896 A, data serving as a reference such as the CAD data is not indicated when three-dimensional data is acquired by the three-dimensional scanner, and thus it is difficult for a user to grasp whether necessary three-dimensional data has been acquired.

### SUMMARY OF THE INVENTION

The disclosure has been made in view of such a point, and an object thereof is to make it easy for a user to grasp whether necessary three-dimensional data has been acquired when three-dimensional data is acquired by a three-dimensional scanner.

In order to achieve the above object, according to one embodiment of the disclosure, a three-dimensional measurement device that measures a three-dimensional shape of a workpiece can be assumed.

The three-dimensional measurement device includes: a three-dimensional scanner including a scanner light source that emits pattern light, and a scanner imaging part that captures the pattern light emitted by the scanner light source and generates an image including the pattern light; a three-dimensional coordinate generation unit that sequentially generates three-dimensional coordinates of a reference workpiece based on the image including the pattern light generated by the scanner imaging part; a three-dimensional data generation unit that generates reference three-dimensional shape data of the reference workpiece based on the three-dimensional coordinates sequentially generated by the three-dimensional coordinate generation unit; a display control part that generates display data for causing a display unit to display the reference three-dimensional shape data generated by the three-dimensional data generation unit; a setting unit that sets a measurement element for the reference three-dimensional shape data generated by the three-dimensional data generation unit and displayed on the display unit; a measurement unit that performs measurement based on the measurement element set by the setting unit; a storage unit that stores, as measurement reproduction templates, setting files each of which is obtained by linking the reference three-dimensional shape data generated by the three-dimensional data generation unit to the measurement element set by the setting unit; a reception unit that receives selection of one template from among the measurement reproduction templates stored in the storage unit; a reading unit that reads the reference three-dimensional shape data and the measurement element included in the one template received by the reception unit; and a registration unit that registers the reference three-dimensional shape data and the measurement element, which are read by the reading unit, as referred three-dimensional shape data and a referred measurement element.

The three-dimensional coordinate generation unit may sequentially generate three-dimensional coordinates of a measurement workpiece based on the image including the pattern light generated by the scanner imaging part, the display control part may sequentially generate display data in which the three-dimensional coordinates of the measurement workpiece sequentially generated by the three-dimensional coordinate generation unit are superimposed on a three-dimensional shape based on the referred three-dimensional shape data registered by the registration unit, the three-dimensional data generation unit may generate three-dimensional shape data of the measurement workpiece based on the three-dimensional coordinates of the measurement workpiece, and the measurement unit may perform measurement based on the referred measurement element registered by the registration unit and the three-dimensional shape data of the measurement workpiece.

According to this configuration, when an image of the workpiece is captured by the scanner imaging part of the three-dimensional scanner, the reference three-dimensional shape data of the reference workpiece is generated and displayed on the display unit. The measurement element can be set for the reference three-dimensional shape data displayed on the display unit. The reference three-dimensional shape data and the measurement element are registered as the referred three-dimensional shape data and the referred measurement element, respectively. When the scanner imaging part captures an image of the measurement workpiece, pieces of the display data in which the three-dimensional coordinates of the sequentially generated measurement workpiece are superimposed on the three-dimensional shape based on the referred three-dimensional shape data are sequentially generated. Therefore, when three-dimensional data is acquired by the three-dimensional scanner, it is easy for a user to grasp whether necessary three-dimensional data is acquired.

According to another embodiment of the disclosure, a three-dimensional measurement method of measuring a three-dimensional shape of a workpiece can be assumed. In the three-dimensional measurement method, it is possible to capture an image of pattern light emitted by a scanner light source to generate an image including the pattern light; to sequentially generate three-dimensional coordinates of a reference workpiece based on the generated image including the pattern light; to generate reference three-dimensional shape data of the reference workpiece based on the sequentially generated three-dimensional coordinates; to display the generated reference three-dimensional shape data on a display unit and to set a measurement element for the reference three-dimensional shape data displayed on the display unit; to store, as measurement reproduction templates, setting files each of which is obtained by linking the generated reference three-dimensional shape data to the set measurement element; to receive selection of one template from among the stored measurement reproduction templates; to read the reference three-dimensional shape data and the measurement element included in the received one template; to register the read reference three-dimensional shape data and the read measurement element as referred three-dimensional shape data and a referred measurement element; to sequentially generate display data in which sequentially generated three-dimensional coordinates of a measurement workpiece are superimposed on a three-dimensional shape based on the registered referred three-dimensional shape data; to generate three-dimensional shape data of the measurement workpiece based on the three-dimensional coordinates of the measurement workpiece; and to measure the measurement workpiece based on the registered referred measurement element and the three-dimensional shape data of the measurement workpiece.

According to still another embodiment of the disclosure, a storage medium storing a three-dimensional measurement program for causing a computer to execute a three-dimensional measurement method of measuring a three-dimensional shape of a workpiece may be provided.

As described above, it becomes easy for the user to grasp whether the necessary three-dimensional data has been acquired.

### BRIEF DESCRIPTION OF THE DRAWINGS

FIG. 1 is a view illustrating a configuration of a three-dimensional measurement device according to the embodiment of the invention;

FIG. 2 is a block diagram of an imaging unit and a processing unit;

FIG. 3 is a perspective view of a three-dimensional scanner as viewed from below;

FIG. 4 is a block diagram illustrating a circuit configuration of the three-dimensional scanner;

FIG. 5 is a block diagram illustrating a circuit configuration of a probe;

FIG. 6 is a view illustrating an example of a user interface screen;

FIG. 7 is a view illustrating a display example of mesh data;

FIG. 8 is a view illustrating an example in which a plane is set as a measurement element;

FIG. 9 is a flowchart illustrating an example of a flow of measurement processing;

FIG. 10 is a view illustrating an example of a user interface screen for measurement illustrating a state in which a measurement workpiece coordinate system is generated;

FIG. 11 is a view illustrating an example of the user interface screen for measurement illustrating a state in which a reference workpiece and the measurement workpiece are aligned;

FIG. 12 is a view illustrating an example of the user interface screen for measurement in the middle of measurement by the three-dimensional scanner;

FIG. 13 is a view illustrating an example of the user interface screen for measurement in a case where the measurement by the three-dimensional scanner is completed;

FIG. 14 is a view illustrating an example of the user interface screen for measurement in a case where mesh data of the measurement workpiece at a certain distance is deleted from mesh data of a setting file;

FIG. 15 is a view illustrating an example of the user interface screen for measurement in a case where the measurement element of the measurement workpiece is extracted;

FIG. 16 is a flowchart illustrating an example of processing in a case where a display color of the mesh data is changed according to a setting;

FIG. 17 is a conceptual view in a case where the display color of the mesh data is changed according to the setting; and

FIG. 18 is a flowchart illustrating an example of processing according to progress of scanning.

### DETAILED DESCRIPTION

Hereinafter, an embodiment of the invention will be described in detail with reference to the drawings. Note that the following preferred embodiment is described merely as an example in essence, and there is no intention to limit the invention, its application, or its use.

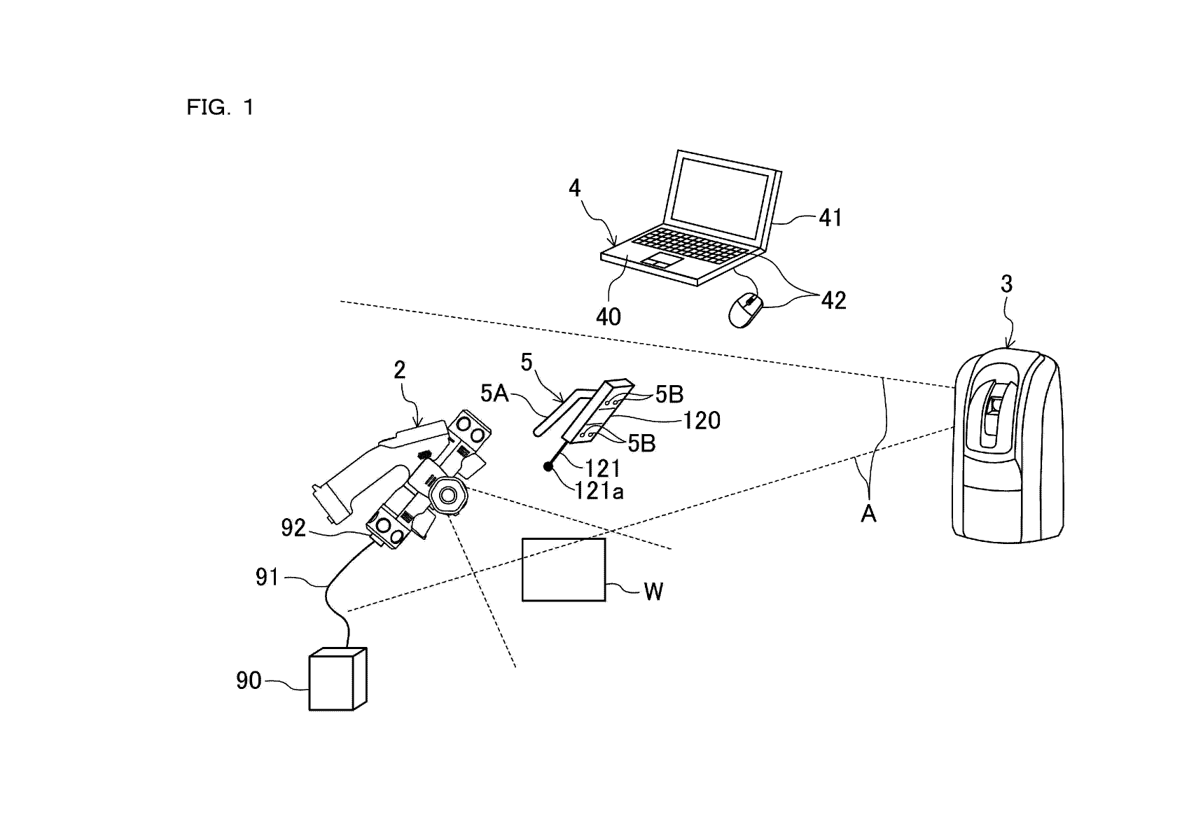

FIG. 1 is a view illustrating a configuration of a three-dimensional measurement device 1 according to the embodiment of the invention. The three-dimensional measurement device 1 is a measuring instrument that measures a three-dimensional shape and three-dimensional coordinates of a workpiece W, and includes a non-contact-type three-dimensional scanner 2 including a plurality of self-luminous markers (scanner markers), a contact-type probe 5 including a plurality of self-luminous markers (probe markers), an imaging unit 3 that captures images of the plurality of scanner markers included in the three-dimensional scanner 2 and images of the plurality of probe markers included in the probe 5, and a processing unit 4 that measures the three-dimensional shape and three-dimensional coordinates of the workpiece W. The markers are not necessarily self-luminous markers. The three-dimensional scanner 2 is provided separately from the imaging unit 3 and the processing unit 4, and a measurement worker can bring the three-dimensional scanner 2 to the vicinity of the workpiece W located at a place distant from the imaging unit 3 and the processing unit 4 and cause the three-dimensional scanner 2 to generate a bright line image. Further, the probe 5 is provided separately from the imaging unit 3 and the processing unit 4, and the measurement worker can bring the probe 5 to the vicinity of the workpiece W located at a place distant from the imaging unit 3 and the processing unit 4 and specify a measurement point using the probe 5.

### (Configuration of Imaging Unit 3)

The imaging unit 3 is a unit that captures images of a plurality of scanner markers (described later) provided in the three-dimensional scanner 2 to generate a scanner marker image including the plurality of scanner markers, and captures images of a plurality of probe markers (described later) provided in the probe 5 to generate a probe marker image including the plurality of probe markers. The scanner marker image including the scanner markers is generated at the time of measurement using the three-dimensional scanner 2, and the probe marker image including the probe markers is generated at the time of measurement using the probe 5.

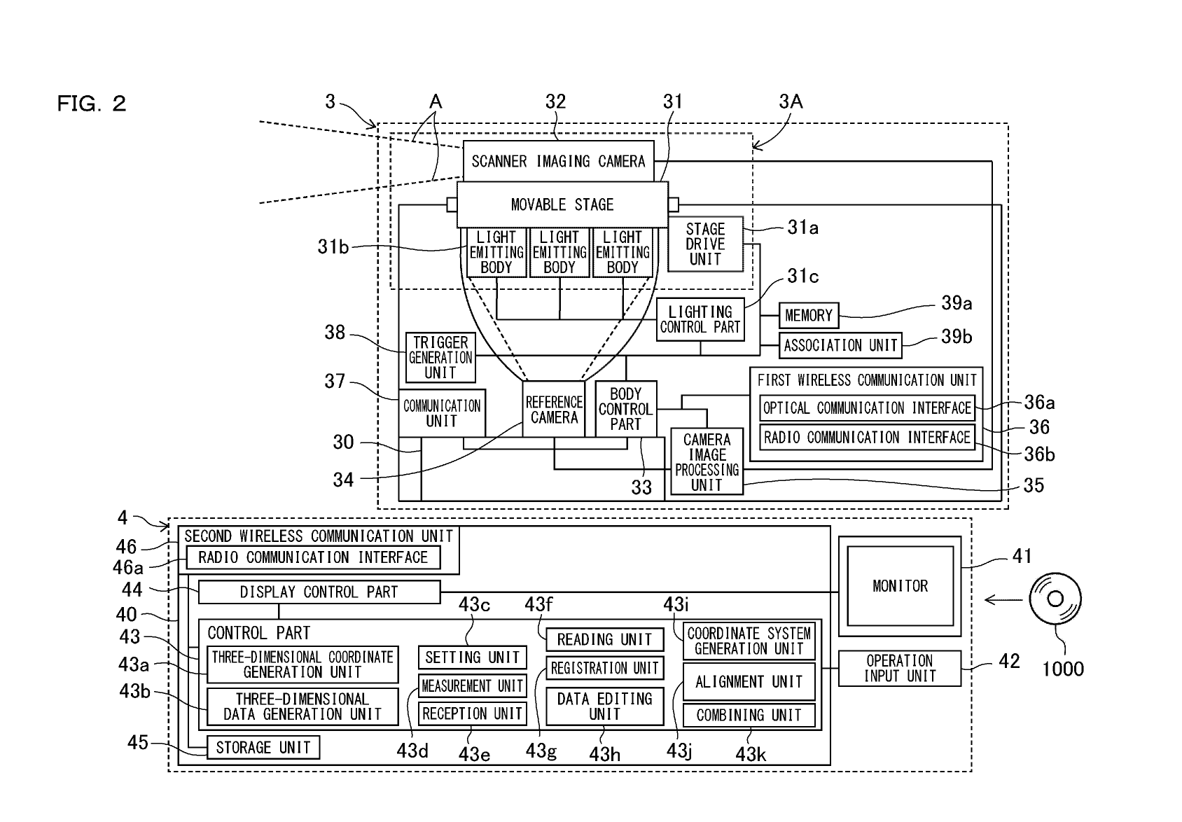

As illustrated in FIG. 2, the imaging unit 3 includes a base 30 and a movable imaging part 3A that moves a field of view such that the three-dimensional scanner 2 is within the field of view, and captures images of scanner markers to measure a position and a posture of the three-dimensional scanner 2 to generate a marker image including the scanner markers. The movable imaging part 3A includes a movable stage 31 supported by the base 30 and a scanner imaging camera 32 fixed to an upper portion of the movable stage 31. The movable stage 31 includes a stage drive unit 31a. The stage drive unit 31a incorporates an actuator such as a motor, and is configured to rotate the movable stage 31 about a left-right axis as well as a vertical axis. Further, the scanner imaging camera 32 rotates about the vertical axis by rotating the movable stage 31 about the vertical axis, and the scanner imaging camera 32 rotates about the left-right axis by rotating the movable stage 31 about the left-right axis. As a result, the scanner marker can be tracked by moving a field of view (schematically indicated by broken lines A in FIGS. 1 and 2) of the scanner imaging camera 32 such that the three-dimensional scanner 2, that is, the plurality of scanner markers provided in the three-dimensional scanner 2, enter the field of view of the scanner imaging camera 32. Similarly, the probe markers of the probe 5 can also be tracked. The stage drive unit 31a is controlled by a body control part 33 provided in the imaging unit 3.

In a lower portion of the movable stage 31, a plurality of light emitting bodies 31b are provided at predetermined intervals on a two-dimensional plane, and the light emitting bodies 31b are switched between a turned-on state and a turned-off state by a lighting control part 31c. Further, arrangement information of each of the light emitting bodies 31b is stored in advance in the imaging unit 3. Note that a member serving as a mark other than the light emitting body may be used. The lighting control part 31c is controlled by the body control part 33. On the other hand, the base 30 is provided with a reference camera 34 that captures an image of the movable imaging part 3A. The reference camera 34 captures an image of the light emitting body 31b turned on by the lighting control part 31c. The reference camera 34 captures images of a plurality of the light emitting bodies 31b provided in the movable imaging part 3A and generates an image including the light emitting bodies 31b.

The imaging unit 3 is provided with a camera image processing unit 35. The camera image processing unit 35 includes an image processing circuit, and controls the scanner imaging camera 32 to execute imaging at a predetermined timing. The scanner imaging camera 32 captures images of scanner markers of the three-dimensional scanner 2 to generate a scanner marker image including the scanner markers. Further, the scanner imaging camera 32 captures images of probe markers of the probe 5 to generate a probe marker image including the probe markers.

Examples of the image processing circuit include a graphics processing unit (GPU), a field programmable gate array (FPGA), a digital signal processor (DSP), and the like. The camera image processing unit 35 receives an input of the scanner marker image or the probe marker image captured by the scanner imaging camera 32 and an input of images of the light emitting bodies 31b captured by the reference camera 34.

The camera image processing unit 35 processes the scanner marker image captured by the scanner imaging camera 32 to generate center position information of the scanner marker. Specifically, the camera image processing unit 35 performs processing of extracting the center of the scanner marker with respect to the scanner marker image. Then, the center position information of the scanner marker is generated based on an extracted result. Furthermore, the camera image processing unit 35 generates position and posture information of the scanner marker with respect to the movable imaging part 3A based on the center position information of the scanner marker obtained as a result of the processing of extracting the center of the scanner marker.

Further, the camera image processing unit 35 processes the probe marker image captured by the scanner imaging camera 32 to generate center position information of the probe marker as in the case of the scanner marker. Position and posture information of the probe marker with respect to the movable imaging part 3A is generated based on the center position information of the probe marker.

The imaging unit 3 includes a first wireless communication unit 36 that is controlled by the body control part 33. The first wireless communication unit 36 is a communication module or the like configured to be capable of communicating with equipment other than the imaging unit 3. In this example, the imaging unit 3 communicates with the three-dimensional scanner 2 and the probe 5 via the first wireless communication unit 36, thereby enabling, for example, transmission and reception of various types of data such as image data captured by the scanner imaging camera 32, various signals such as a synchronization signal, and the like.

The first wireless communication unit 36 transmits, for example, the synchronization signal to the three-dimensional scanner 2 and the probe 5, and receives measurement information (edge data) generated by a scanner image processing unit 147 described later. Further, the center position information of the scanner marker, which is the measurement information generated by the camera image processing unit 35, and the center position information of the probe marker, which is the measurement information generated by the camera image processing unit 35, are transmitted to the processing unit 4. The first wireless communication unit 36 includes an optical communication interface 36a and a radio communication interface 36b. The optical communication interface 36a is a part configured to perform optical communication using visible light or invisible light, and can be configured by, for example, an infrared communication interface or the like. The radio communication interface 36b may be, for example, a part configured to construct a wireless LAN, or may be a part capable of short-range digital wireless communication using radio waves such as Bluetooth (registered trademark) communication.

The imaging unit 3 also includes a communication unit 37 that is controlled by the body control part 33. The communication unit 37 is a communication module or the like configured to be capable of communicating with the processing unit 4. The imaging unit 3 communicates with the processing unit 4 via the communication unit 37, thereby enabling, for example, transmission and reception of various types of data such as image data and various signals. The communication by the communication unit 37 may be wired communication or wireless communication.

The imaging unit 3 includes the trigger generation unit 38 that generates identification information for identifying a synchronous execution timing based on a measurement instruction. For example, when the measurement worker performs a predetermined measurement start operation, the body control part 33 of the imaging unit 3 receives the measurement start operation. When receiving the measurement start operation, the body control part 33 causes the trigger generation unit 38 to generate a trigger as the above-described identification information. The trigger is transmitted to the three-dimensional scanner 2 via the optical communication interface 36a of the first wireless communication unit 36, for example. In the case of using the probe 5, the trigger is transmitted to the probe 5 via the optical communication interface 36a.

In response to the generation of the trigger, the body control part 33 synchronously executes light emission of the scanner markers of the three-dimensional scanner 2, imaging of the scanner markers of the three-dimensional scanner 2 by the movable imaging part 3A, lighting of the light emitting bodies 31b of the movable stage 31, and imaging of the light emitting bodies 31b by the reference camera 34. The body control part 33 synchronously executes the light emission of the scanner markers of the three-dimensional scanner 2, the imaging by the movable imaging part 3A, and the imaging by the reference camera 34.

The radio communication interface 36b of the first wireless communication unit 36 transmits the center position information of the scanner marker generated by the camera image processing unit 35 and the identification information that is generated by the trigger generation unit 38 and corresponds to the center position information of the scanner marker to be tied to each other. For example, center position information of a scanner marker is linked to identification information for distinguishing the center position information of the scanner marker from center position information of another scanner marker. Thus, center position information of a desired scanner marker can be specified based on the identification information.

### (Configuration of Processing Unit 4)

The processing unit 4 is a three-dimensional data generation unit that receives positions and postures of a plurality of scanner markers obtained by processing the scanner marker image generated by the imaging unit 3 from the imaging unit 3, receives edge data of the bright line image obtained by processing the bright line image generated by the three-dimensional scanner 2, and measures a three-dimensional shape of the workpiece W based on the received positions and postures of the scanner markers and the edge data.

An example of a technique for measuring a three-dimensional shape will be described. Since the plurality of light emitting bodies 31b of the imaging unit 3 are provided on the movable stage 31 to which the scanner imaging camera 32 is fixed, a positional relationship of the plurality of light emitting bodies 31b with respect to the scanner imaging camera 32 is known. When the scanner imaging camera 32 is moved by the stage drive unit 31a, the scanner imaging camera 32 moves within a range in which images of the light emitting bodies 31b can be captured by the reference camera 34. A position and a posture of the three-dimensional scanner 2 with respect to the scanner imaging camera 32 are determined based on the scanner marker image of the three-dimensional scanner 2 captured by the scanner imaging camera 32.

Further, the reference camera 34 similarly determines a position and a posture of the scanner imaging camera 32 with respect to the reference camera 34 based on the images obtained by capturing the plurality of light emitting bodies 31b. Specifically, the camera image processing unit 35 processes the images of the light emitting bodies 31b generated by the reference camera 34 to generate position and posture information of the scanner imaging camera 32 with respect to the reference camera 34.

A position and a posture of the three-dimensional scanner 2 with respect to the reference camera 34 are determined from the position and posture of the three-dimensional scanner 2 with respect to the scanner imaging camera 32 and the position and posture of the scanner imaging camera 32 with respect to the reference camera 34, and coordinates of a measurement point are obtained, so that three-dimensional coordinate measurement, that is, three-dimensional shape measurement becomes possible.

As a three-dimensional measurement program or an application for implementing functions of the three-dimensional measurement device 1 is installed in the processing unit 4, the processing unit 4 can be used as the three-dimensional measurement device 1, and a three-dimensional measurement method according to the invention can be executed. The three-dimensional measurement method is a method of measuring a three-dimensional shape of the workpiece W, and is executed by the processing unit 4 which is a computer. The three-dimensional measurement program for causing the computer to execute the three-dimensional measurement method can be recorded in a storage medium 1000. The storage medium 1000 may be, for example, an optical disk such as a CD-ROM or a DVD-ROM, or may be a semiconductor memory such as a memory card.

The processing unit 4 may be provided separately from the imaging unit 3 or may be integrated with the imaging unit 3. Further, a part of the processing unit 4 may be incorporated in the imaging unit 3, or a part of the imaging unit 3 may be incorporated in the processing unit 4.

As illustrated in FIG. 2, the processing unit 4 includes a control unit 40, a monitor 41, and an operation input unit 42. The monitor 41 is configured by a liquid crystal display, an organic EL display, or the like configured to be capable of displaying various images, a user interface, and the like.

The operation input unit 42 is a part by which a user performs various input operations. The operation input unit 42 includes, for example, a keyboard, a mouse, and the like.

The control unit 40 includes a control part 43, a display control part 44, a storage unit 45, and a second wireless communication unit 46. The display control part 44 is a part that controls the monitor 41 based on a signal output from the control part 43, and causes the monitor 41 to display various images, a user interface, and the like. The user's operation performed on the user interface is acquired by the control part 43 based on a signal output from the operation input unit 42.

The storage unit 45 may be a ROM, a solid state drive, a hard disk drive, or the like. The storage unit 45 stores arrangement information of each of scanner markers in marker blocks provided in the three-dimensional scanner 2. The arrangement information of the marker block and each of the scanner markers includes a distance between the marker blocks, information indicating a relative positional relationship of the self-luminous markers provided in each of the marker blocks, and the like.

Further, the second wireless communication unit 46 of the processing unit 4 is controlled by the control part 43. The second wireless communication unit 46 is a communication module or the like configured to be capable of communicating with the first wireless communication unit 36 of the imaging unit 3. The second wireless communication unit 46 includes a radio communication interface 46a. The radio communication interface 46a of the second wireless communication unit 46 receives the edge data which is the measurement information transmitted via the radio communication interface 36b of the first wireless communication unit 36 of the imaging unit 3, the center position information of the scanner marker, and the center position information of the probe marker.

### (Configuration of Three-Dimensional Scanner 2)

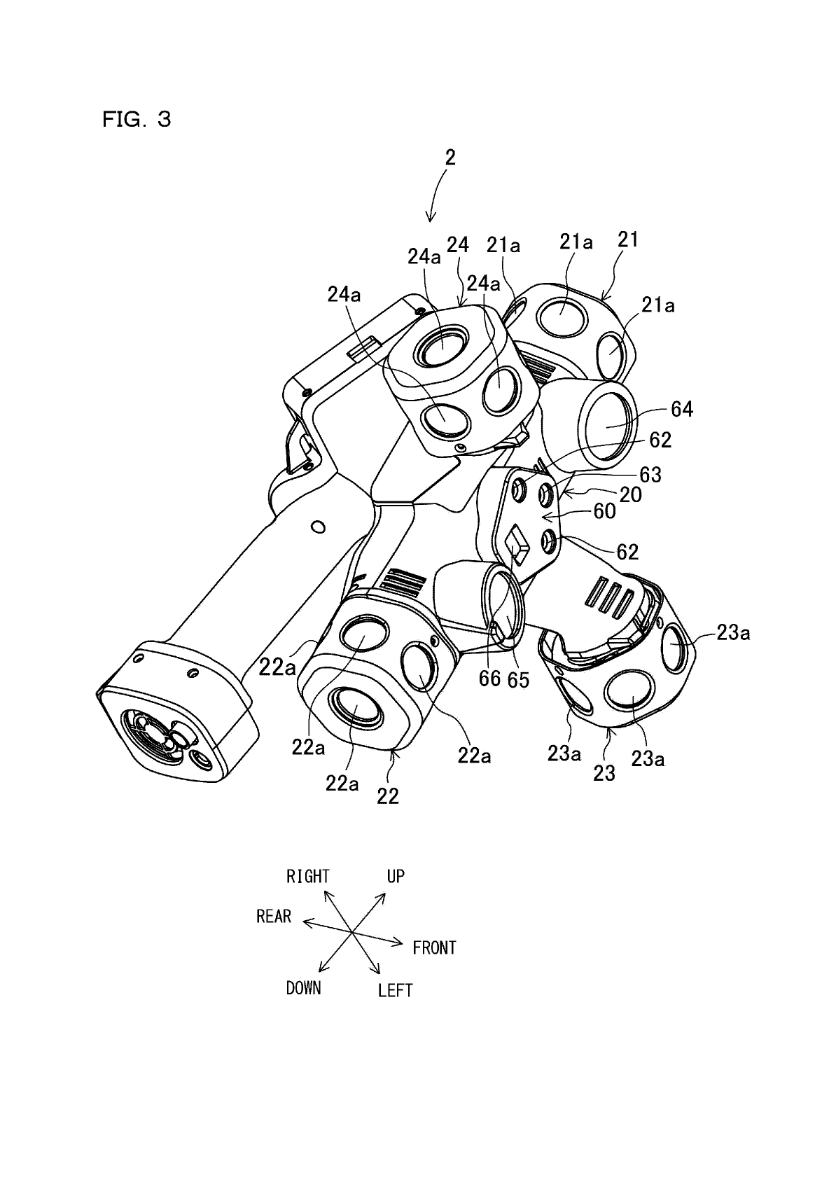

The three-dimensional scanner 2 is configured such that the measurement worker can measure a shape of the workpiece W while holding and freely moving the three-dimensional scanner 2 with one hand or both hands, and is a handheld and portable scanner. In the present embodiment, the front, rear, left, right, up, down of the three-dimensional scanner 2 are defined as illustrated in FIG. 3. That is, when the measurement worker holds the three-dimensional scanner 2 by hand, a side located on the right is referred to as the right, and a side located on the left is referred to as the left. The front of the three-dimensional scanner 2 is a side opposing the workpiece W, and the rear side of the three-dimensional scanner 2 is a side opposite to the side opposing the workpiece W. The up of the three-dimensional scanner 2 is a side on the upper side in a state where a grip part 112, which will be described later, is gripped in a natural posture as determined, and the down of the three-dimensional scanner 2 is a side on the lower side in a state where the grip part 112 is gripped in the natural posture as determined. However, since the three-dimensional shape of the workpiece W can be measured while the three-dimensional scanner 2 is held and moved by hand as described above, the three-dimensional scanner 2 may have an orientation of being inverted upside down or a posture in which the upper side is located on the right or left, or the rear side thereof may be located at the up or down.

The three-dimensional scanner 2 includes the scanner body 20, a first marker block 21, a second marker block 22, a third marker block 23, and a fourth marker block 24. The first to fourth marker blocks 21 to 24 each have self-luminous scanner markers 21a, 22a, 23a, and 24a facing in a plurality of directions, respectively. Each of the scanner markers 21a, 22a, 23a, and 24a includes, for example, a light emitting diode (LED).

The scanner body 20 includes the scanner unit 60. The scanner unit 60 includes two first scanner light sources 62, a second scanner light source 63, a first scanner imaging part 64, a second scanner imaging part 65, and a texture camera 66. The two first scanner light sources 62 are multi-line light sources each emitting a plurality of linear light beams in a measurement direction (forward), and are arranged such that light emission surfaces oppose the workpiece W at the time of measurement. The light emitted by the first scanner light source 62 can be referred to as multi-line light, and the multi-line light is included in pattern light.

The second scanner light source 63 is a single-line light source that emits one linear light beam in the measurement direction (forward), and is arranged such that a light emission surface opposes the workpiece W at the time of measurement. The light emitted by the second scanner light source 63 can be referred to as single-line light, and the single-line light is also included in the pattern light.

Each of the first scanner light sources 62 and the second scanner light source 63 includes the laser light source that emits the laser light, but a type of the light source is not particularly limited. Further, a total of three scanner light sources 62 and 63 are provided in this example, but the invention is not limited thereto, and one or more scanner light sources may be provided. Further, a type of the pattern light is not particularly limited, and the scanner light source may emit pattern light other than the multi-line light and the single-line light.

The first scanner imaging part 64 and the second scanner imaging part 65 include, for example, a light receiving element such as a CMOS sensor, an optical system for forming an image of light incident from the outside on a light receiving surface of the light receiving element, and the like. The first scanner imaging part 64 is attached to a portion spaced upward from the scanner light sources 62 and 63. The second scanner imaging part 65 is attached to a portion spaced downward from the scanner light sources 62 and 63. The first scanner imaging part 64 and the second scanner imaging part 65 are arranged such that optical axes thereof are oriented in irradiation directions of beams of the pattern light from the scanner light sources 62 and 63, respectively, and accordingly, it is possible to capture images of beams of the pattern light emitted from the scanner light sources 62 and 63 in the measurement direction and generate the bright line image including the pattern light.

A distance between the optical axes of the first scanner imaging part 64 and the second scanner imaging part 65 is known, a corresponding point between the respective images generated by simultaneously capturing the pattern light emitted from the first scanner light sources 62 or the second scanner light source 63 by the first scanner imaging part 64 and the second scanner imaging part 65 is obtained, and three-dimensional coordinates of the corresponding point can be obtained using the stereo measurement method. The stereo measurement method may be passive stereo using the first scanner imaging part 64 and the second scanner imaging part 65, or may be active stereo using one scanner imaging part.

The texture camera 66 includes, for example, a light receiving element such as a CMOS sensor capable of acquiring a color image, an optical system for forming an image of light incident from the outside on a light receiving surface of the light receiving element, and the like. The texture camera 66 captures an image of the workpiece W to generate a texture image.

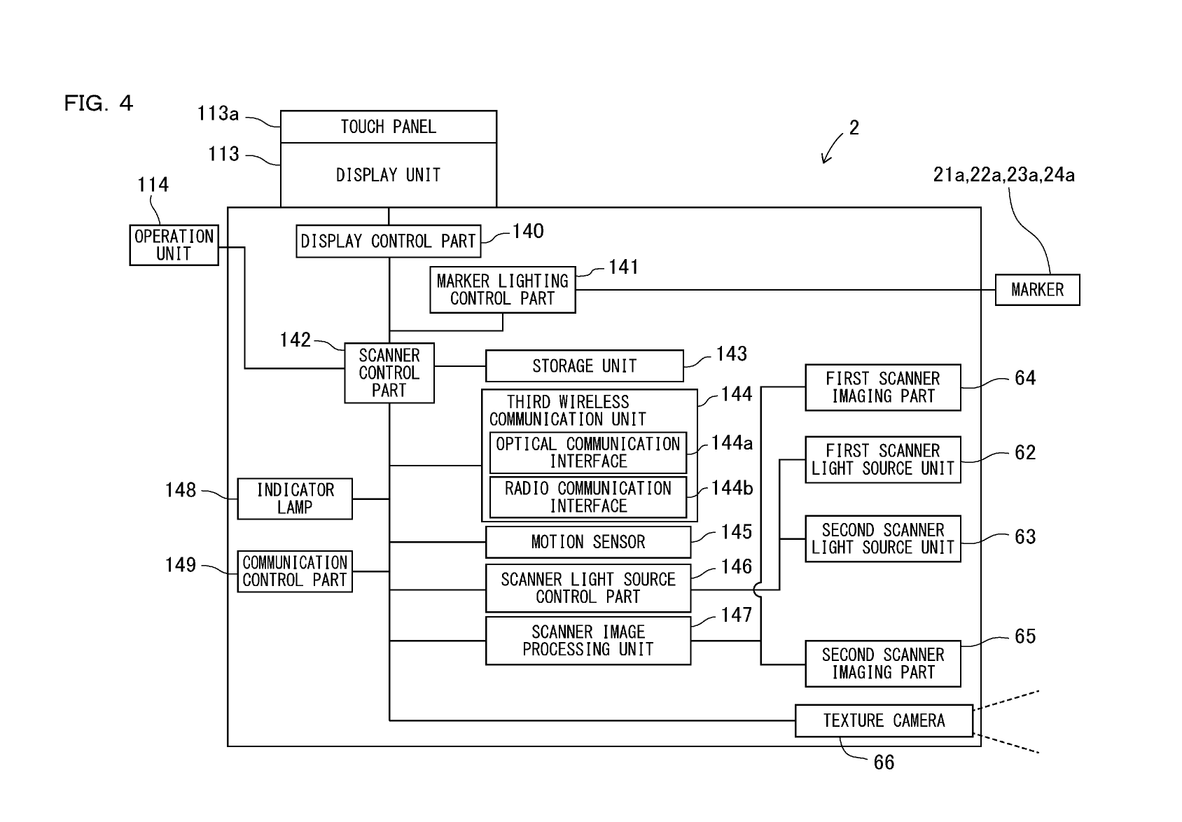

As illustrated in FIG. 4, a display unit (scanner display unit) 113 configured to display a measurement result obtained by the scanner unit 60 and an operation unit 114 configured to operate the scanner unit 60 are provided in the scanner body 20. The display unit 113 is configured by a liquid crystal display, an organic EL display, or the like. Further, a display surface is oriented toward the measurement worker so as to be capable of moving the three-dimensional scanner 2 while viewing a display content of the display unit 113.

A touch panel 113a on which a touch operation can be performed is also provided on the display surface side of the display unit 113. The operation unit 114 includes, for example, a plurality of operation buttons including a measurement start button, a measurement stop button, and the like, and is arranged below the display unit 113. The touch panel 113a can also be a part of the operation unit.

The three-dimensional scanner 2 includes a display control part 140, a marker lighting control part 141, a scanner control part 142, and a storage unit 143. The display control part 140 is a part that controls the display unit 113 based on a signal output from the scanner control part 142, and causes the display unit 113 to display various images, a user interface, and the like. The user's operation performed on the display unit 113 is acquired by the scanner control part 142 based on a signal output from the touch panel 113a.

The marker lighting control part 141 is a part that controls the scanner markers. The scanner markers 21a, 22a, 23a, and 24a are switched between the turned-on state and the turned-off state by the marker lighting control part 141. The marker lighting control part 141 is controlled by the scanner control part 142. The storage unit 143 can temporarily store a control program, an image captured by the scanner unit 60, and the like.

The three-dimensional scanner 2 includes a third wireless communication unit 144 that is controlled by the scanner control part 142. The third wireless communication unit 144 is a communication module or the like configured to be capable of communicating with equipment other than the three-dimensional scanner 2. The third wireless communication unit 144 is a part configured to transmit the edge data generated by the scanner image processing unit 147 to the first wireless communication unit 36 of the imaging unit 3, and receive the synchronization signal transmitted from the first wireless communication unit 36. The third wireless communication unit 144 includes an optical communication interface 144a and a radio communication interface 144b.

The three-dimensional scanner 2 includes a motion sensor 145. The motion sensor 145 includes a sensor that detects an acceleration and an angular velocity of the three-dimensional scanner 2, and detected values are output to the scanner control part 142 and used for various types of calculation processing. For example, a value output from the motion sensor 145 can be used to obtain an initial solution of the posture of the three-dimensional scanner 2, that is, the postures of the first to fourth marker blocks 21 to 24, thereby improving the matching accuracy and improving the processing speed at the time of posture calculation. The processing using the values output from the motion sensor 145 may be executed by the imaging unit 3 or the processing unit 4.

The three-dimensional scanner 2 includes a scanner light source control part 146 and the scanner image processing unit 147. The scanner light source control part 146 controls the first scanner light sources 62 and the second scanner light source 63. The first scanner light source 62 and the second scanner light source 63 are switched between the turned-on state and the turned-off state by the scanner light source control part 146. The scanner light source control part 146 is controlled by the scanner control part 142. Further, the scanner image processing unit 147 controls the first scanner imaging part 64, the second scanner imaging part 65, and the texture camera 66 to execute imaging at a predetermined timing. Images captured by the first scanner imaging part 64, the second scanner imaging part 65, and the texture camera 66 are input to the scanner image processing unit 147. The scanner image processing unit 147 executes various types of image processing such as extraction of edge data on the input images.

That is, the scanner image processing unit 147 generates edge data by performing edge extraction processing on the bright line image generated by the first scanner imaging part 64 or the second scanner imaging part 65. In a case where the first scanner light sources 62 emit the multi-line light, the first scanner imaging part 64 and the second scanner imaging part 65 generate multi-line images. The scanner image processing unit 147 processes the multi-line images to generate the edge data.

The third wireless communication unit 144 transmits the edge data generated by the scanner image processing unit 147 and identification information corresponding to the edge data generated by the trigger generation unit 38 to be tied to each other. That is, the edge data and the identification information for distinguishing the edge data from another edge data are linked to each other. Therefore, it is possible to specify desired edge data based on the identification information.

Further, when the trigger generated by the trigger generation unit 38 of the imaging unit 3 is transmitted to the three-dimensional scanner 2, the three-dimensional scanner 2 receives the trigger as the synchronization signal via the optical communication interface 144a of the third wireless communication unit 144. When the trigger is received, the scanner light source control part 146 executes emission of pattern light from the first scanner light sources 62 or the second scanner light source 63, the scanner image processing unit 147 executes imaging by the first scanner imaging part 64 and the second scanner imaging part 65, and the marker lighting control part 141 causes the scanner markers 21a, 22a, 23a, and 24a to emit light. The emission of pattern light from the first scanner light sources 62 or the second scanner light source 63, the imaging by the first scanner imaging part 64 and the second scanner imaging part 65, and the light emission of the scanner markers 21a, 22a, 23a, and 24a are synchronized with each other.

The three-dimensional scanner 2 transmits the edge data generated by the scanner image processing unit 147 to the imaging unit 3 via the radio communication interface 144b of the third wireless communication unit 144. The imaging unit 3 receives the edge data via the radio communication interface 36b of the first wireless communication unit 36, and transmits the received edge data and the center position information of the scanner marker generated by the camera image processing unit 35 to the second wireless communication unit 46 of the processing unit 4.

The three-dimensional scanner 2 includes an indicator lamp 148 and the communication control part 149. The indicator lamp 148 displays an operation state of the three-dimensional scanner 2, and is controlled by the scanner control part 142. The communication control part 149 is a part that performs processing of executing communication of, for example, image data and the like.

### (Contact-Type Probe)

The contact-type probe 5 is a handheld or portable probe similarly to the three-dimensional scanner 2. As illustrated in FIG. 1, the probe 5 includes a probe body 120 and a stylus 121 protruding from the probe body 120. A contact 121a configured to make contact with the workpiece W is provided at a tip of the stylus 121. The contact 121a has, for example, a spherical shape. The contact 121a is a part configured to designate a position of a measurement point of the workpiece W, various designation points, and the like. Further, the probe body 120 has a grip part 5A at an intermediate part thereof in the longitudinal direction, and a measurement worker can grip the grip part 5A with one hand and move the probe 5 or change the orientation at the time of measurement.

The probe body 120 is provided with a plurality of probe markers 5B spaced apart from each other. For example, a plurality of probe markers 5B are spaced apart from each other on one end side of the probe body 120 in the longitudinal direction, and a plurality of probe markers 5B are also spaced apart from each other on the other end side of the probe body 120 in the longitudinal direction.

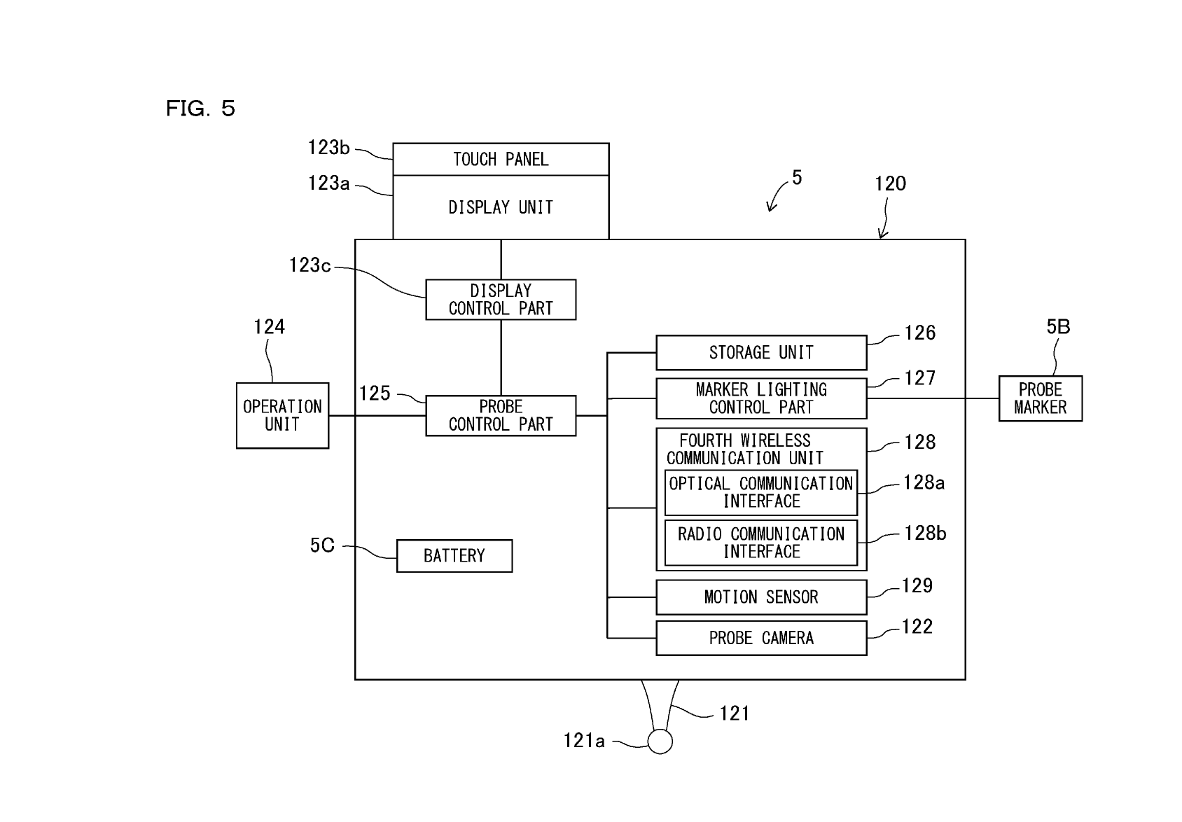

FIG. 5 illustrates a circuit configuration of the probe 5. Although only one probe marker 5B is illustrated in FIG. 5, the plurality of probe markers 5B are provided in practice. A probe camera 122 is provided in the vicinity of the stylus 121. The probe 5 includes a display unit 123a configured by a liquid crystal display, an organic EL display, or the like, a touch panel 123b that is operated by a touch, and a display control part 123c. Further, an operation unit 124 including a plurality of buttons and the like is provided in the vicinity of the display unit 123a. The probe 5 further includes a probe control part 125, a storage unit 126, a probe marker lighting control part 127, a fourth wireless communication unit 128, a motion sensor 129, and the like. Further, the probe 5 also includes a battery 5C serving as a power source.

The display control part 123c is a part that controls the display unit 123a based on a signal output from the probe control part 125, and causes the display unit 123a to display various images, a user interface, and the like. The user's operation performed on the display unit 123a is acquired by the probe control part 125 based on a signal output from the touch panel 123b.

The probe marker lighting control part 127 is a part that controls the probe marker 5B. The probe marker 5B is switched between a turned-on state and a turned-off state by the probe marker lighting control part 127. The probe marker lighting control part 127 is controlled by the probe control part 125. A control program and the like can be stored in the storage unit 126.

Similarly to the first wireless communication unit 36 of the imaging unit 3, the fourth wireless communication unit 128 includes an optical communication interface 128a and a radio communication interface 128b. The optical communication interface 128a is a part that receives the trigger transmitted via the optical communication interface 36a of the imaging unit 3. When the trigger is received, the probe marker lighting control part 127 turns on the probe marker 5B. As a result, imaging of the probe marker by the imaging unit 3 and lighting of the probe marker 5B can be synchronized. The radio communication interface 128b may have a radio communication system different from that of the radio communication interface 144b of the three-dimensional scanner 2, and for example, when the radio communication interface 144b of the three-dimensional scanner 2 constructs a wireless LAN, the radio communication interface 128b of the fourth wireless communication unit 128 can be configured as a part capable of Bluetooth communication or the like having a communication speed lower than that of the wireless LAN.

The motion sensor 129 includes a sensor that detects an acceleration and an angular velocity of the probe 5, and detected values are output to the probe control part 125 and used for various types of calculation processing such as posture calculation of the probe 5, similarly to the posture calculation of the three-dimensional scanner 2.

### (Processing Content by Processing Unit)

The processing unit 4 includes a three-dimensional coordinate generation unit 43a, a three-dimensional data generation unit 43b, a setting unit 43c, and a measurement unit 43d. The three-dimensional coordinate generation unit 43a is a part that sequentially generates three-dimensional coordinates of a reference workpiece and three-dimensional coordinates of a measurement workpiece based on images including pattern light generated by the first scanner imaging part 64 and the second scanner imaging part 65. Further, the three-dimensional data generation unit 43b is a part that generates reference three-dimensional shape data of the reference workpiece and three-dimensional shape data of the measurement workpiece based on the three-dimensional coordinates sequentially generated by the three-dimensional coordinate generation unit 43a. For example, in a case where an invalid point is included in the three-dimensional coordinates generated by the three-dimensional coordinate generation unit 43a, the three-dimensional data generation unit 43b can convert final points remaining after a data editing unit 43h described later removes the invalid point into point cloud data or mesh data.

Specifically, if the processing unit 4 receives, via the second wireless communication unit 46, the center position information of the scanner marker generated by the camera image processing unit 35 when the first scanner imaging part 64 and the second scanner imaging part 65 of the three-dimensional scanner 2 have captured the images of the reference workpiece, the three-dimensional coordinate generation unit 43a sequentially generates the three-dimensional coordinates of the reference workpiece. Further, the three-dimensional data generation unit 43b acquires edge data generated by the scanner image processing unit 147, the center position information of the scanner marker generated by the camera image processing unit 35, and the position and posture information of the scanner imaging camera 32. The three-dimensional data generation unit 43b generates point cloud data or mesh data indicating a three-dimensional shape of the reference workpiece based on the edge data, the center position information of the scanner marker, and the position and posture information of the scanner imaging camera 32. Point cloud data or mesh data can be generated similarly for the measurement workpiece.

The edge data is calculated for each of the multi-line images generated by the first scanner imaging part 64 and the second scanner imaging part 65. The edge data is calculated by specifying a change in a luminance value for each Y coordinate of the multi-line image and performing arithmetic processing such as differential processing on the change in the luminance value. That is, the edge data is data indicating a position (X coordinate) of a bright line in each Y coordinate.

Further, the center position information of each of the self-luminous markers 21a, 22a, 23a, and 24a is generated by the following method. First, the camera image processing unit 35 acquires the arrangement information of each of the self-luminous markers 21a, 22a, 23a, and 24a from the storage unit 143 of the three-dimensional scanner 2. Then, the camera image processing unit 35 calculates any position at which an image of each of the markers 21a, 22a, 23a, and 24a is captured by the imaging unit 3 when a relative position or posture of the three-dimensional scanner 2 with respect to the imaging unit 3 is changed based on the arrangement information of the self-luminous markers 21a, 22a, 23a, and 24a acquired from the storage unit 143 of the three-dimensional scanner 2 and relative three-dimensional position information between the markers included in the marker image generated by the camera image processing unit 35, and matches the calculated position of each of the markers 21a, 22a, 23a, and 24a with a marker position on an image. Then, a relative position and posture of the three-dimensional scanner 2 with respect to the imaging unit 3 in which an error between the calculated position of each of the markers 21a, 22a, 23a, and 24a and the marker position on the image is minimized are calculated and generated as the center position information of each of the self-luminous markers 21a, 22a, 23a, and 24a. That is, the camera image processing unit 35 virtually changes the arrangement information of each of the self-luminous markers 21a, 22a, 23a, and 24a acquired from the storage unit 143 of the three-dimensional scanner 2 by virtually changing the position and posture of the three-dimensional scanner 2, calculates a position and a posture matching the marker image generated by the camera image processing unit 35, and generates the center position information of each of the self-luminous markers 21a, 22a, 23a, and 24a. This position and posture information calculation processing may be called bundle adjustment.

The center position information of each of the self-luminous markers 21a, 22a, 23a, and 24a calculated here uses the scanner imaging camera 32 as a reference. In this regard, the camera image processing unit 35 calculates position and posture information of the three-dimensional scanner 2 using the reference camera 34 as a reference based on position and posture information of the scanner imaging camera 32 using the reference camera 34 as a reference and the position and posture information of the three-dimensional scanner 2 using the scanner imaging camera 32 as a reference, thereby generating the center position information of each of the self-luminous markers 21a, 22a, 23a, and 24a using the reference camera 34 as a reference.

When imaging is executed, the three-dimensional coordinate generation unit 43a receives edge data generated by the scanner image processing unit 147, identification information corresponding to the edge data, center position information of each of the scanner markers generated by the camera image processing unit 35, and identification information corresponding to the center position information of each of the scanner markers. The three-dimensional coordinate generation unit 43a can generate a point cloud indicating a three-dimensional shape of the workpiece W based on the edge data, the identification information corresponding to the edge data, the center position information of each of the self-luminous markers, the identification information corresponding to the center position information of each of the self-luminous markers, and the calibration data of the three-dimensional scanner 2 stored in the storage unit 45 of the processing unit 4.

As illustrated in FIG. 2, the imaging unit 3 includes a memory 39a that sequentially accumulates pieces of the edge data generated by the scanner image processing unit 147, and an association unit 39b that associates pieces of the edge data with pieces of the center position information of the scanner markers based on identification information. For example, in a case of sequentially measuring a plurality of the workpieces W or in a case of sequentially measuring different portions of the same workpiece W, the scanner image processing unit 147 generates a plurality of pieces of the edge data. The plurality of pieces of generated edge data are transmitted from the third wireless communication unit 144 of the three-dimensional scanner 2 to the imaging unit 3 with mutually different pieces of identification information being tied thereto. The plurality of pieces of edge data transmitted from the third wireless communication unit 144 of the three-dimensional scanner 2 are accumulated in the memory 39a of the imaging unit 3 with pieces of the identification information being tied thereto.

When the three-dimensional coordinate generation unit 43a is caused to generate the point cloud indicating the three-dimensional shape, the association unit 39b specifies center position information of a scanner marker to be transmitted to the three-dimensional coordinate generation unit 43a. The association unit 39b specifies edge data having identification information tied to the specified center position information of the scanner marker from among the plurality of pieces of edge data accumulated in the memory 39a. Thereafter, the association unit 39b associates the specified edge data with the center position information of the scanner marker. The communication unit 37 of the imaging unit 3 transmits the edge data specified by the association unit 39b and the center position information of the scanner marker in association with each other to the three-dimensional coordinate generation unit 43a.

At the time of measurement by the probe 5, the measurement worker brings the contact 121a into contact with a point (measurement point) of the workpiece W to be measured, and then operates the operation unit 124. Then, the trigger generation unit 38 generates a trigger to execute light emission of the probe marker 5B, imaging of the probe marker, light emission of the light emitting body 31b, and imaging of the light emitting body 31b by the reference camera 34 in synchronization. The camera image processing unit 35 generates the center position information of the probe marker. The processing unit 4 receives center position information of the probe marker generated by the camera image processing unit 35 via the second wireless communication unit 46. The three-dimensional coordinate generation unit 43a generates three-dimensional coordinates of the measurement point pointed by the contact 121a based on the center position information of the probe marker generated by the camera image processing unit 35 and position and posture information of the scanner imaging camera 32.

### (CREATION OF SETTING FILE)

In creating the setting file, first, a coordinate system is set using the contact-type probe 5. In the present embodiment, for example, a reference coordinate system can be defined with any part of the reference workpiece as a reference. In this case, similarly to a design drawing of the reference workpiece, the reference coordinate system based on any part of the reference workpiece is set, and coordinates of a measurement position are calculated according to the reference coordinate system. When the reference coordinate system is set, the reference coordinate system can be set with any part of the reference workpiece as the reference regardless of a position and a posture of the reference workpiece.

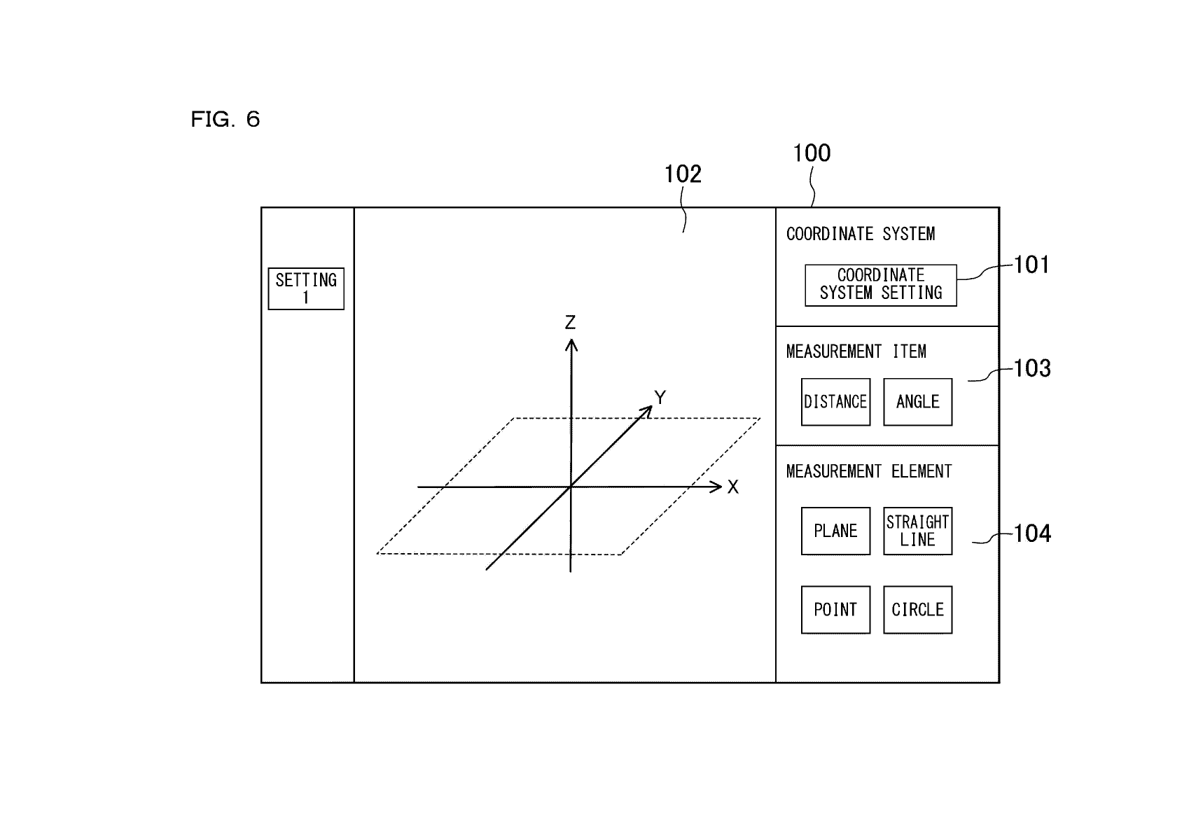

When the user performs a setting start operation, the display control part 44 generates a user interface screen 100 illustrated in FIG. 6 and displays the user interface screen 100 on the monitor 41. The user interface screen 100 is provided with a coordinate system setting button 101, an image display area 102, a measurement item setting area 103, and a measurement element setting area 104. In the image display area 102, the set reference coordinate system, various images, and the like are displayed. In the measurement item setting area 103, for example, there are a “distance” for measuring a distance between two geometric elements, an “angle” for measuring an angle of two geometric elements, and the like as measurement items, which can be selected by the user. In the measurement element setting area 104, there are a “plane”, a “straight line”, a “point”, a “circle”, and the like as measurement elements, which can be selected by the user.

When detecting that the coordinate system setting button 101 of the user interface screen 100 has been operated, the control part 43 operates in a coordinate system setting mode. In the coordinate system setting mode, a coordinate system generation unit 43i included in the control part 43 generates a reference workpiece coordinate system based on positions of a plurality of measurement points indicated on the reference workpiece by the contact-type probe 5.

In this embodiment, in order to set the reference coordinate system, the coordinate system generation unit 43i sequentially sets one plane, one straight line, and one point. In the coordinate system setting mode, the user designates one face (for example, the upper face) of the reference workpiece as the “plane”. When the “plane” is designated, four points separated apart from each other on the one face of the reference workpiece are sequentially designated by the contact-type probe 5. When designation of three points is completed, a plane passing through the three points is set as the “plane”, and a position of the plane is calculated. This plane is defined as an XY plane, for example.

Further, for designating the “straight line” after the designation of the plane, it is sufficient to sequentially designate two points separated from each other on one face of the reference workpiece using the contact-type probe 5. Further, for designating the “point”, it is sufficient to sequentially designate points on one face of the reference workpiece using the contact-type probe 5. A method for setting the reference coordinate system is not particularly limited, and for example, the reference coordinate system may be set by setting three planes including a point at which the origin is to be set as measurement planes.

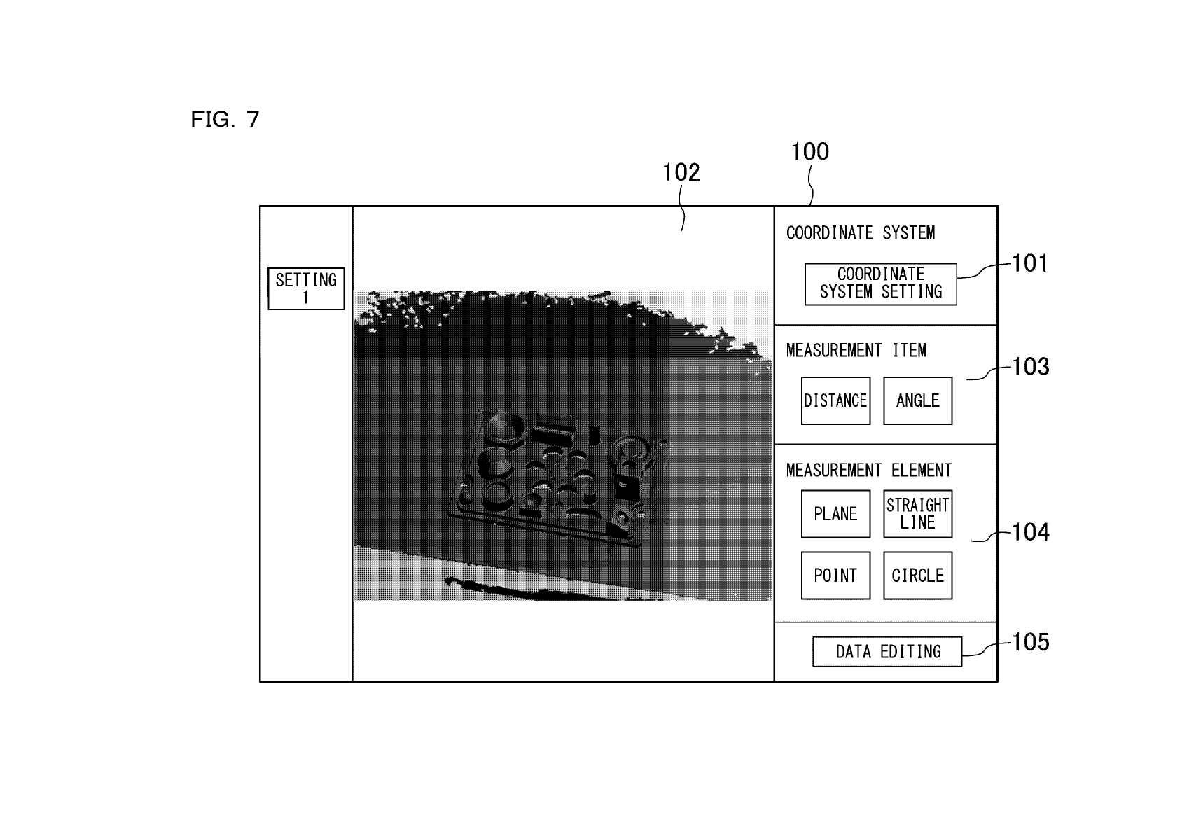

When the setting of the reference coordinate system is completed, the reference workpiece is scanned by the non-contact type three-dimensional scanner 2. Then, the three-dimensional coordinate generation unit 43a sequentially generates three-dimensional coordinates of the reference workpiece based on images including pattern light generated by the scanner imaging parts 64 and 65. When the three-dimensional coordinates of the reference workpiece are generated, the three-dimensional data generation unit 43b generates reference three-dimensional shape data of the reference workpiece based on the three-dimensional coordinates sequentially generated by the three-dimensional coordinate generation unit 43a. When the reference three-dimensional shape data is generated by the three-dimensional data generation unit 43b, the display control part 44 generates display data for displaying the reference three-dimensional shape data on the monitor (display unit) 41. On the monitor 41, the reference three-dimensional shape data is displayed in the image display area 102 of the user interface screen 100, for example, as illustrated in FIG. 7.

After mesh data is acquired as a three-dimensional shape of the reference workpiece in this manner, desired mesh data is obtained by partially deleting (removing) unnecessary data from the acquired mesh data. That is, for example, a data editing button 105 is provided on the user interface screen 100 illustrated in FIG. 7, and when the user operates the data editing button 105, data editing by the data editing unit 43h included in the control part 43 is enabled. For example, the data editing unit 43h deletes data of a background part other than the reference workpiece or deletes data of an unnecessary part in the reference workpiece. The data of the unnecessary part may include an invalid point. For deleting data, it is sufficient for the user to designate a region to be deleted, and only data of the region designated by the user is deleted, and necessary mesh data is generated by the three-dimensional data generation unit 43b. After the generation of the mesh data by the three-dimensional data generation unit 43b, deletion of an unnecessary point may be performed.

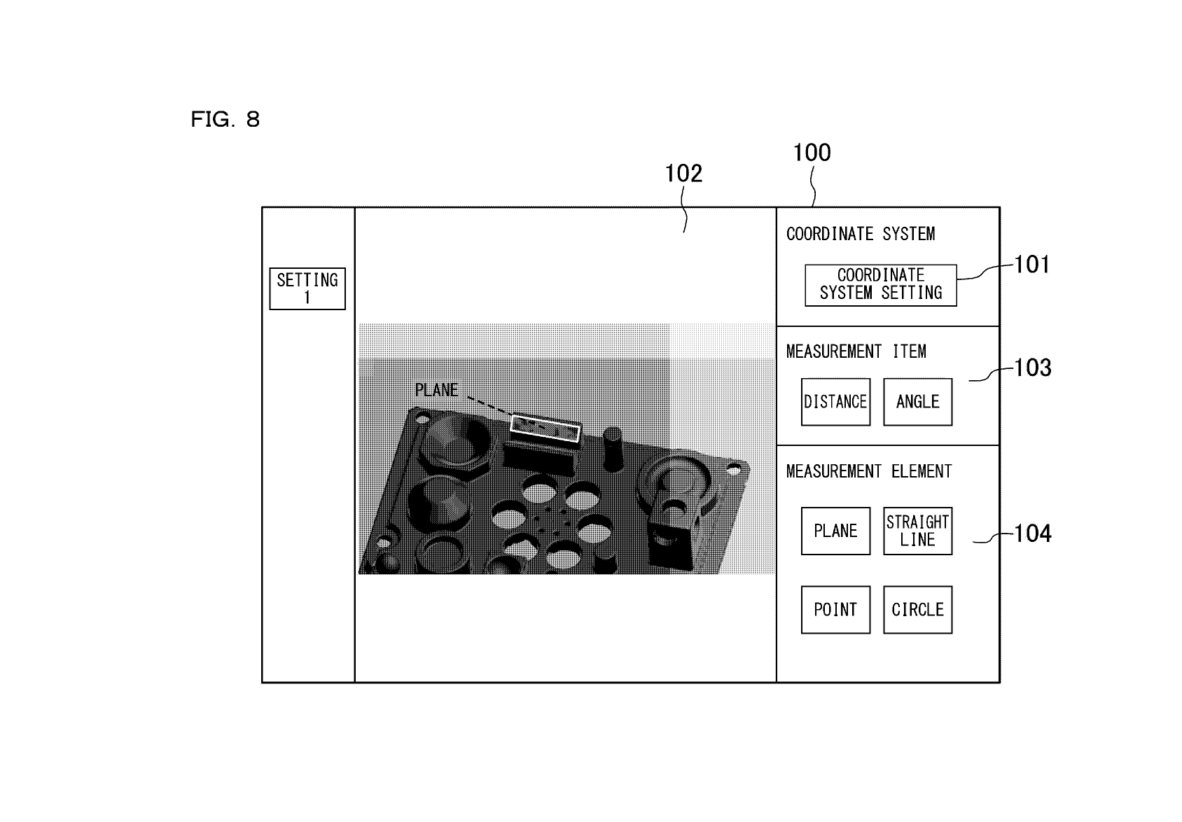

The setting unit 43c is a part that sets a measurement element for the reference three-dimensional shape data generated by the three-dimensional data generation unit 43b and displayed on the monitor 41. The setting of the measurement element can be performed through the measurement item setting area 103 and the measurement element setting area 104 of the user interface screen 100 illustrated in FIG. 7. For example, as illustrated in FIG. 8, when it is desired to set the “plane” as a measurement element for the reference three-dimensional shape data displayed on the monitor 41, the “plane” in the measurement element setting area 104 is selected. Then, the setting unit 43c sets the “plane” as the measurement element.

The measurement unit 43d is a part that performs measurement based on the measurement element set by the setting unit 43c. The measurement unit 43d measures the “distance”, the “angle”, and the like selected in the measurement item setting area 103.

When the measurement element is set by the setting unit 43c, a setting file in which the reference three-dimensional shape data generated by the three-dimensional data generation unit 43b and the measurement element set by the setting unit 43c are linked to each other is generated. This setting file is stored in the storage unit 45 as a measurement reproduction template. Only one measurement reproduction template may be stored in the storage unit 45, or a plurality of measurement reproduction templates may be stored.

In setting the measurement element, not only extraction of a plane from a scan result but also comparison with CAD data serving as a reference can be included in the measurement element.

The processing unit 4 includes a reception unit 43e, a reading unit 43f, and a registration unit 43g. The reception unit 43e is a part that receives selection of one measurement reproduction template from among measurement reproduction templates stored in the storage unit 45. For example, in a state in which a list of measurement reproduction templates stored in the storage unit 45 is displayed on the monitor 41, the user can select a desired measurement reproduction template by operating the operation input unit 42. When the reception unit 43e receives such a selection operation performed by the user, it is possible to specify one selected measurement reproduction template.

The reading unit 43f is a part that reads the reference three-dimensional shape data and the measurement element included in one measurement reproduction template received by the reception unit 43e from the storage unit 45. The registration unit 43g is a part that registers the reference three-dimensional shape data and the measurement element read by the reading unit 43f as referred three-dimensional shape data and a referred measurement element, respectively.

In order to reproduce measurement of the measurement element at the time of measurement processing to be described later, a line-of-sight direction, a click position, an operation history, and the like when the setting file is created are stored in the setting file. For example, the reception unit 43e receives an input of an extraction reference point when a geometric element that is a measurement element is extracted on the monitor 41 and selection of a type of the geometric element to be extracted. The input of the extraction reference point and the selection of the type of the geometric element are performed by the user. The type of the geometric element is, for example, a plane, a straight line, or the like. The storage unit 45 stores, as measurement elements, the extraction reference point received by the reception unit 43e, a display posture or the line-of-sight direction of a measurement workpiece on the monitor 41 when the extraction reference point is received, and the type of the geometric element.

### (Measurement Processing)

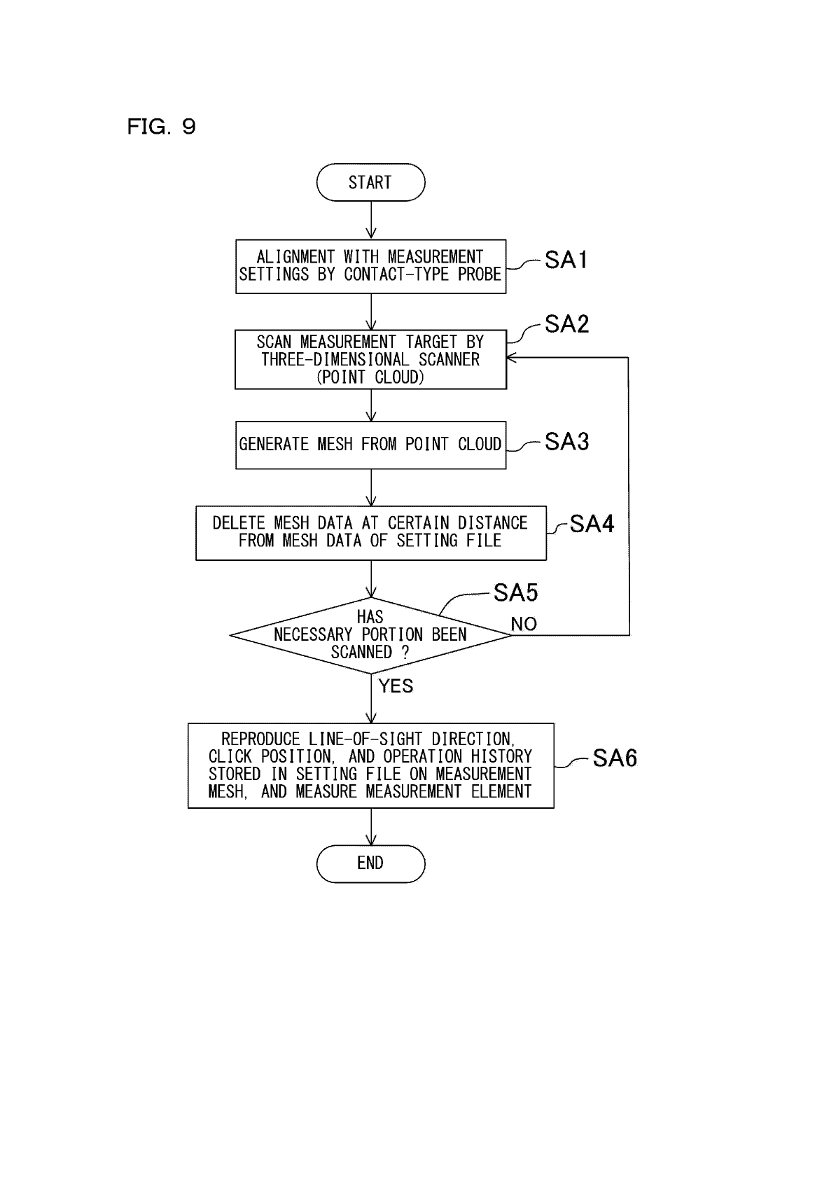

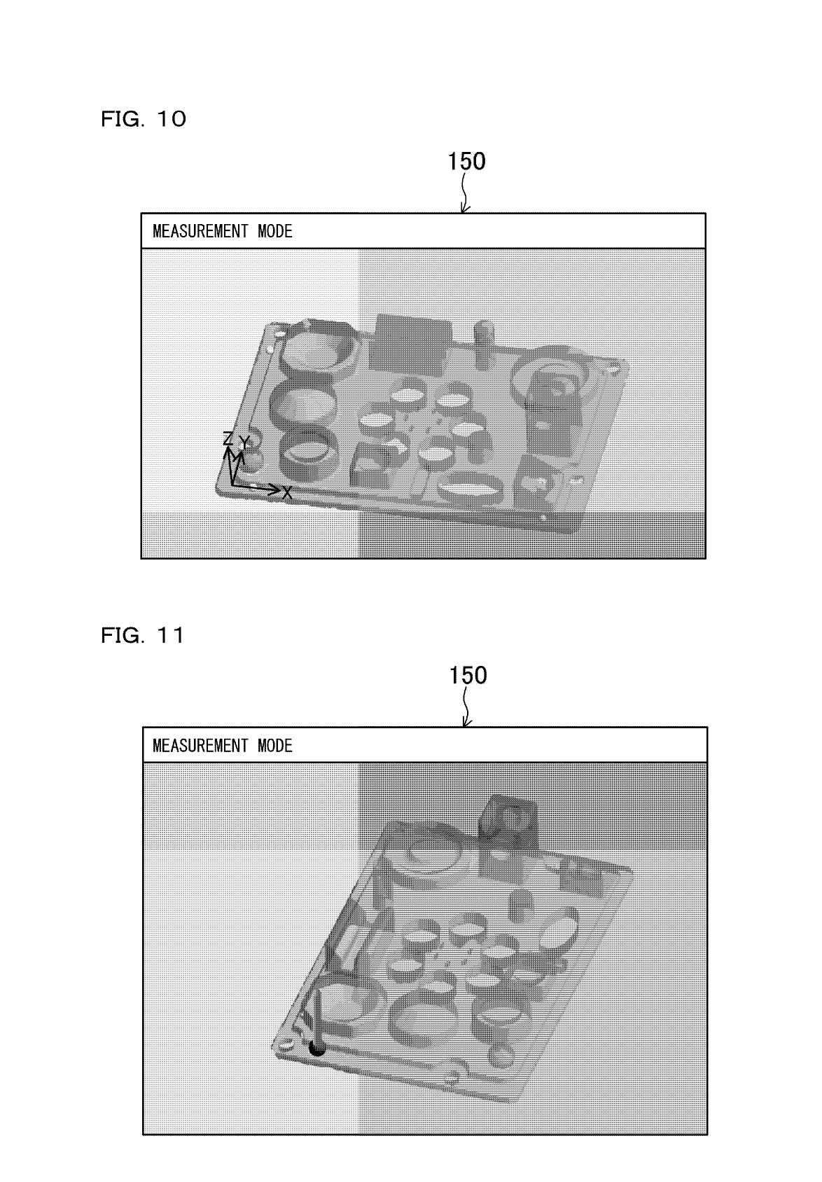

After storing the setting file as the measurement reproduction template in the storage unit 45, the user executes the measurement processing. The measurement processing can be performed according to a flowchart illustrated in FIG. 9. In Step SA1 after the start, alignment with a measurement setting by the contact-type probe 5 is performed. For example, as described above, one plane, one straight line, and one point are sequentially set by the contact-type probe 5. In this manner, the coordinate system generation unit 43i can generate a measurement workpiece coordinate system based on a plurality of measurement points indicated on the measurement workpiece W by the contact-type probe 5. FIG. 10 illustrates a user interface screen 150 for measurement illustrating a state in which the measurement workpiece coordinate system is generated, and this user interface screen 150 for measurement is displayed on the monitor 41.

As illustrated in FIG. 2, the control part 43 includes an alignment unit 43j. After the coordinate system generation unit 43i generates the measurement workpiece coordinate system, the alignment unit 43j of the control part 43 aligns the reference workpiece and the measurement workpiece based on the reference workpiece coordinate system and the measurement workpiece coordinate system generated by the coordinate system generation unit 43i. A method for the alignment using the contact-type probe 5 is not limited to a method of creating and referring to elements such as a plane and a straight line to create a coordinate system, and other methods may be used.

FIG. 11 illustrates the user interface screen 150 for measurement displayed on the monitor 41 when the alignment between the reference workpiece and the measurement workpiece is completed. As the alignment is performed using the contact-type probe 5, mesh data of the setting file and a position of the measurement workpiece coincide.

When this alignment is performed, the mesh data of the reference workpiece, which is the scan result of the setting file, that is, the referred three-dimensional shape data is displayed on the user interface screen 150 for measurement illustrated in FIG. 11. At this time, the referred measurement element may also be displayed on the user interface screen 150 for measurement. The mesh data of the reference workpiece serves as a guide when the user scans the measurement workpiece by the three-dimensional scanner 2.

In a state in which the mesh data of the setting file serving as the guide is displayed on the monitor 41 in Step SA1 illustrated in FIG. 9, the processing proceeds to Step SA2 and transitions to scanning of the measurement workpiece by the three-dimensional scanner 2. Here, although the CAD data serving as the reference can be displayed on the monitor 41 as a guide, there is a case where it is difficult to present which portion of a measurement target workpiece is to be measured by scanning only by displaying the CAD data. In such a case, as in the present embodiment, by displaying the mesh data of the setting file as the guide on the monitor 41 instead of the CAD data, not only a shape of the workpiece but also a specific measurement portion in the workpiece can be presented to the user, and the measurement portion can be more appropriately scanned by the user.

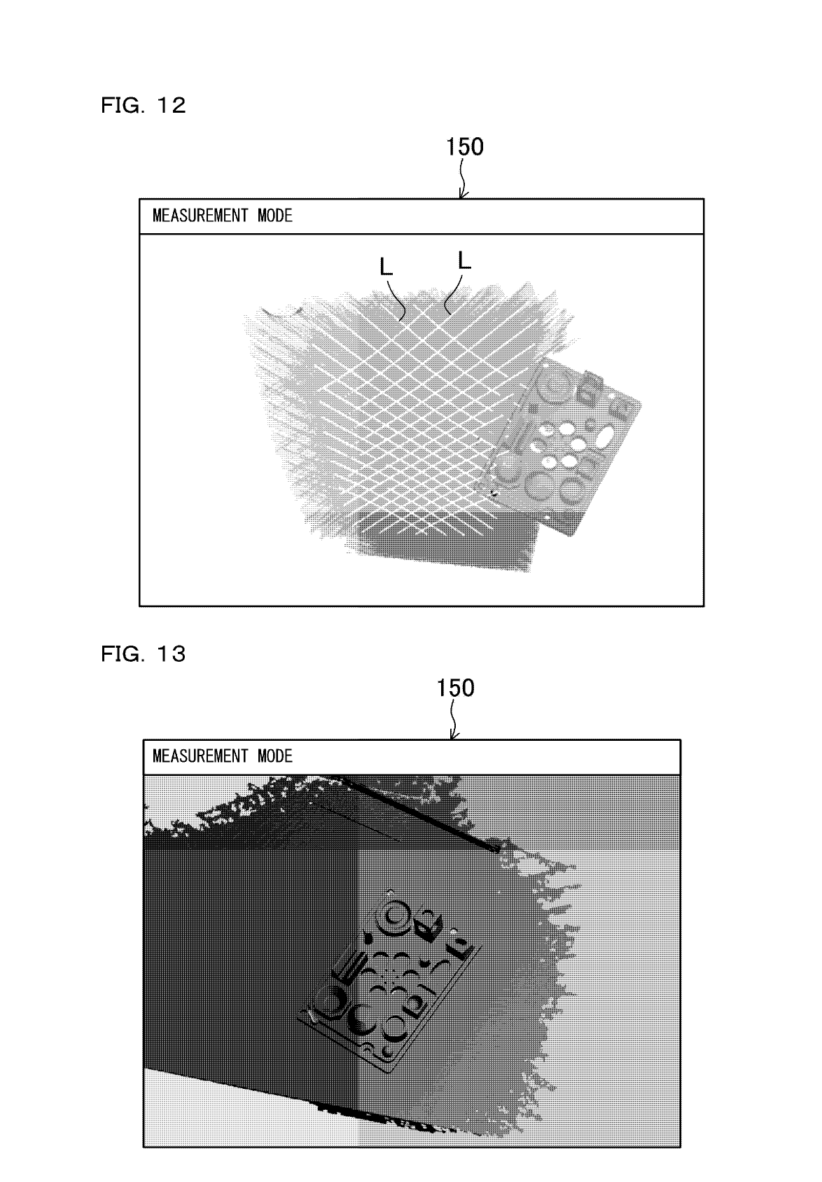

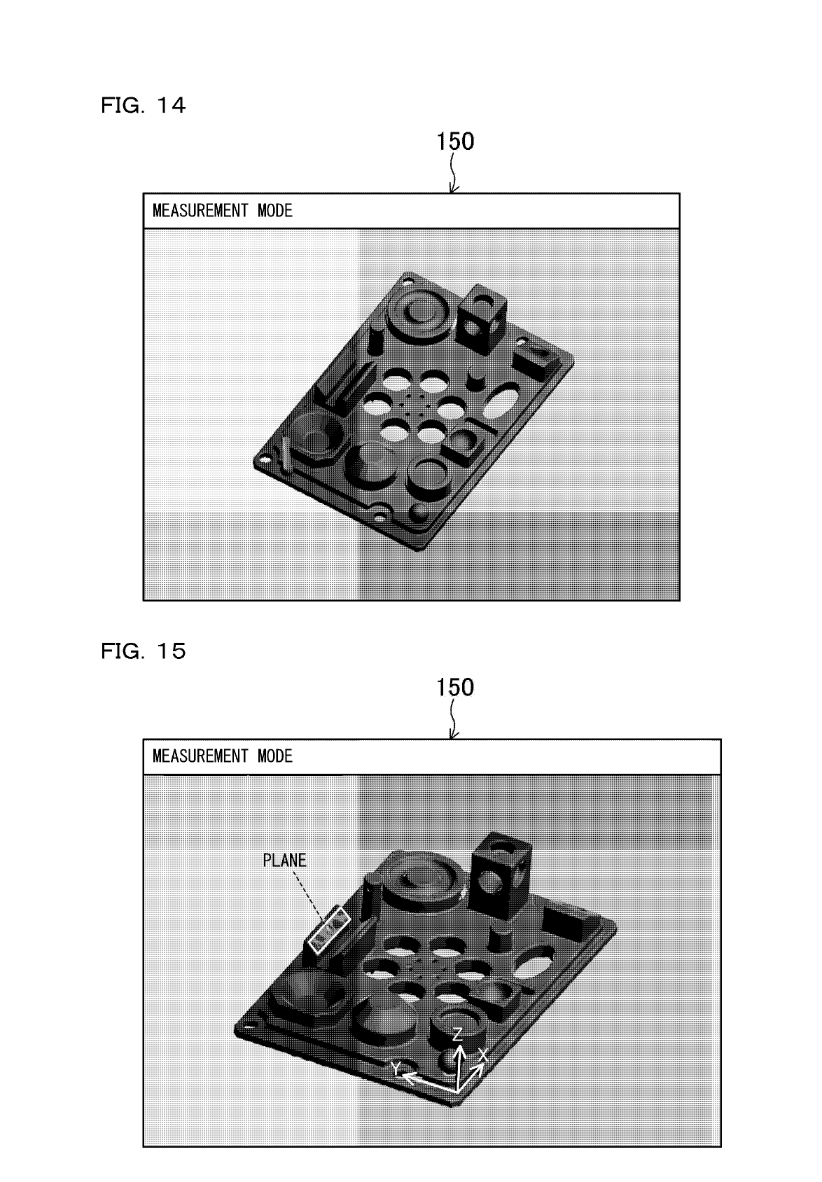

FIG. 12 illustrates the user interface screen 150 for measurement displayed on the monitor 41 when the measurement by the three-dimensional scanner 2 is performed in a state in which the mesh data of the setting file is displayed as the guide on the monitor 41. A line denoted by reference sign L in FIG. 12 indicates the multi-line light emitted from the first scanner light sources 62 of the three-dimensional scanner 2.

As illustrated in FIG. 12, when the user scans the measurement workpiece using the three-dimensional scanner 2, the three-dimensional coordinate generation unit 43a sequentially generates three-dimensional coordinates of the measurement workpiece based on images including pattern light generated by the scanner imaging parts 64 and 65. Then, the display control part 44 sequentially generates display data in which the three-dimensional coordinates of the measurement workpiece sequentially generated by the three-dimensional coordinate generation unit 43a are superimposed on a three-dimensional shape based on the referred three-dimensional shape data registered by the registration unit 43g. Since an image based on the generated display data is incorporated in the user interface screen 150 for measurement and displayed on the monitor 41, the user can perform efficient scanning while grasping whether a necessary range has been scanned in real time by viewing the monitor 41. The user can also grasp that the measurement portion has been scanned. When the measurement portion has not been scanned, the user may move the three-dimensional scanner 2 such that the measurement portion can be scanned.

The wireless communication unit 144 of the three-dimensional scanner 2 sequentially receives the display data in which the three-dimensional coordinates of the measurement workpiece are superimposed on the three-dimensional shape based on the referred three-dimensional shape data sequentially generated by the display control part 44 of the processing unit 4. The scanner display unit 113 of the three-dimensional scanner 2 displays the display data received by the wireless communication unit 144. In this manner, since the user interface screen 150 for measurement as illustrated in FIG. 12 is displayed on the scanner display unit 113 of the three-dimensional scanner 2 held by the user, the user can grasp whether the necessary range has been scanned in real time only by viewing the hand.

In Step SA3, the three-dimensional data generation unit 43b generates three-dimensional shape data of the measurement workpiece based on the three-dimensional coordinates of the measurement workpiece acquired in Step SA2. FIG. 13 illustrates a state in which the scanning by the three-dimensional scanner 2 is completed, and the three-dimensional shape data of the measurement workpiece is displayed on the monitor 41.

In Step SA4, mesh data of the measurement workpiece at a certain distance from the mesh data (referred three-dimensional shape data) of the setting file is deleted. Step SA4 is a step performed by the data editing unit 43h. The data editing unit 43h partially removes three-dimensional shape data from the three-dimensional shape data of the measurement workpiece based on the distance between the referred three-dimensional shape data and the three-dimensional shape data of the measurement workpiece in a state in which the referred three-dimensional shape data and the three-dimensional shape data of the measurement workpiece are aligned by the alignment unit 43j. For example, when three-dimensional shape data of the measurement workpiece is separated from the referred three-dimensional shape data by a predetermined distance or more, only the three-dimensional shape data of the measurement workpiece separated from the referred three-dimensional shape data by the predetermined distance or more is removed. The “predetermined distance” may be settable by the user.

In Step SA5, the user determines whether a necessary portion of the measurement workpiece has been scanned by the three-dimensional scanner 2. When the necessary portion of the measurement workpiece has not been scanned, the processing proceeds to Step SA2, and the user additionally scans the measurement workpiece by the three-dimensional scanner 2. When the necessary portion of the measurement workpiece has been scanned, the processing proceeds to Step SA5, and the measurement unit 43d performs measurement based on the referred measurement element registered by the registration unit 43g and the three-dimensional shape data of the measurement workpiece. That is, it is possible to measure the set measurement element by obtaining mesh data reproduced in both the position and the shape with respect to the setting file.

The measurement unit 32d acquires a display posture or a line-of-sight direction stored in the storage unit 45 as a measurement element from the setting file. The measurement unit 32d updates the position and posture of the three-dimensional data of the measurement workpiece based on the acquired display posture or line-of-sight direction, extracts a geometric element based on an extraction reference point and a type of the geometric element included in the setting file in the state of the updated position and posture, and performs various types of measurement based on the extracted geometric element (see FIG. 15).

The control part 43 includes a combining unit 43k. The combining unit 43k is a part that acquires three-dimensional coordinates with different parameters and combines the plurality of acquired three-dimensional coordinates to generate one piece of three-dimensional shape data. An example of the parameter is, for example, resolution that is a density of measured points. When the combining unit 43k combines three-dimensional coordinates acquired with a plurality of parameters to generate one piece of three-dimensional shape data, a point cloud acquired with each of the parameters and mesh data obtained by combining the point clouds acquired with the respective parameters are associated with the three-dimensional shape data. In displaying the referred three-dimensional shape data on the monitor 41, the display control part 44 projects the point cloud acquired with each of the parameters on the mesh data to identifiably display data acquired with each of the parameters. Further, not only the resolution but also, for example, an exposure time, a laser type, or the like may be used as the parameter, and a plurality of types of point clouds having different settings may be stored in the storage unit 45. Note that the laser type here is a setting as to whether the multi-line light is used or the single-line light is used as the pattern light. Then, as the respective point clouds acquired with different settings are projected on the mesh data, regions acquired with the respective settings can be displayed on the mesh data in an identifiable manner.

### (Other Embodiments)

The above-described embodiment is merely an example in all respects, and should not be construed as limiting. Furthermore, all modifications and changes belonging to the equivalent range of the claims fall within the scope of the invention.

Examples of a display form of a three-dimensional shape of a reference workpiece may include opaque, translucent, and wire-frame. It may be switchable among opaque, translucent, wire-frame, and the like according to a measurement workpiece. In the opaque display from, the back of the workpiece is not viewable, so that it is possible to distinguish between the front and the back.

In addition to the display of the three-dimensional shape of the reference workpiece, whether a sufficient number of point clouds have been obtained by measurement by the three-dimensional scanner 2 can also be presented to a user by, for example, a color or transparency. For example, by darkening the color on the user interface screen 150 for measurement or reducing the transparency as the number of point clouds increases, the user can determine an end timing of scanning while viewing the color or transparency displayed on the monitor 41 or the scanner display unit 113.

Further, settings at the time of scanning include, for example, resolution, an exposure time, and the like. Different three-dimensional guides may be displayed on the user interface screen 150 for measurement for each resolution or exposure time.

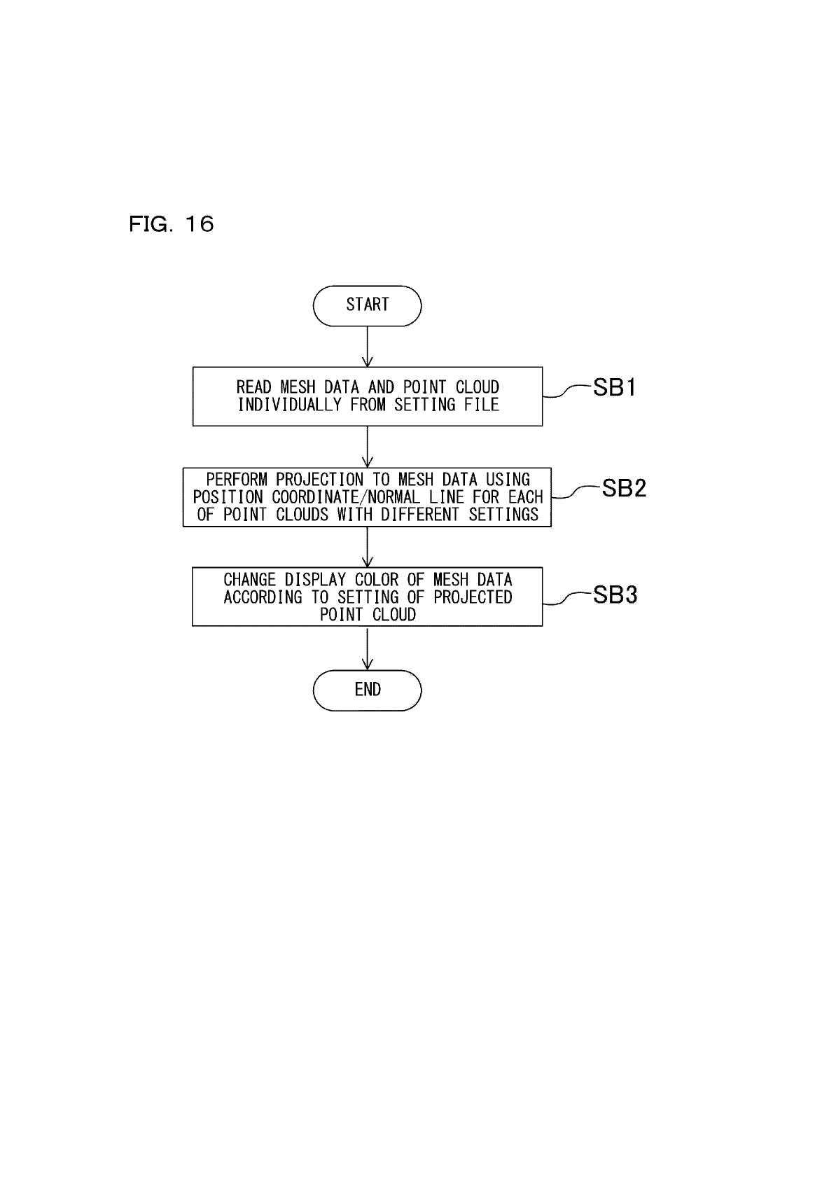

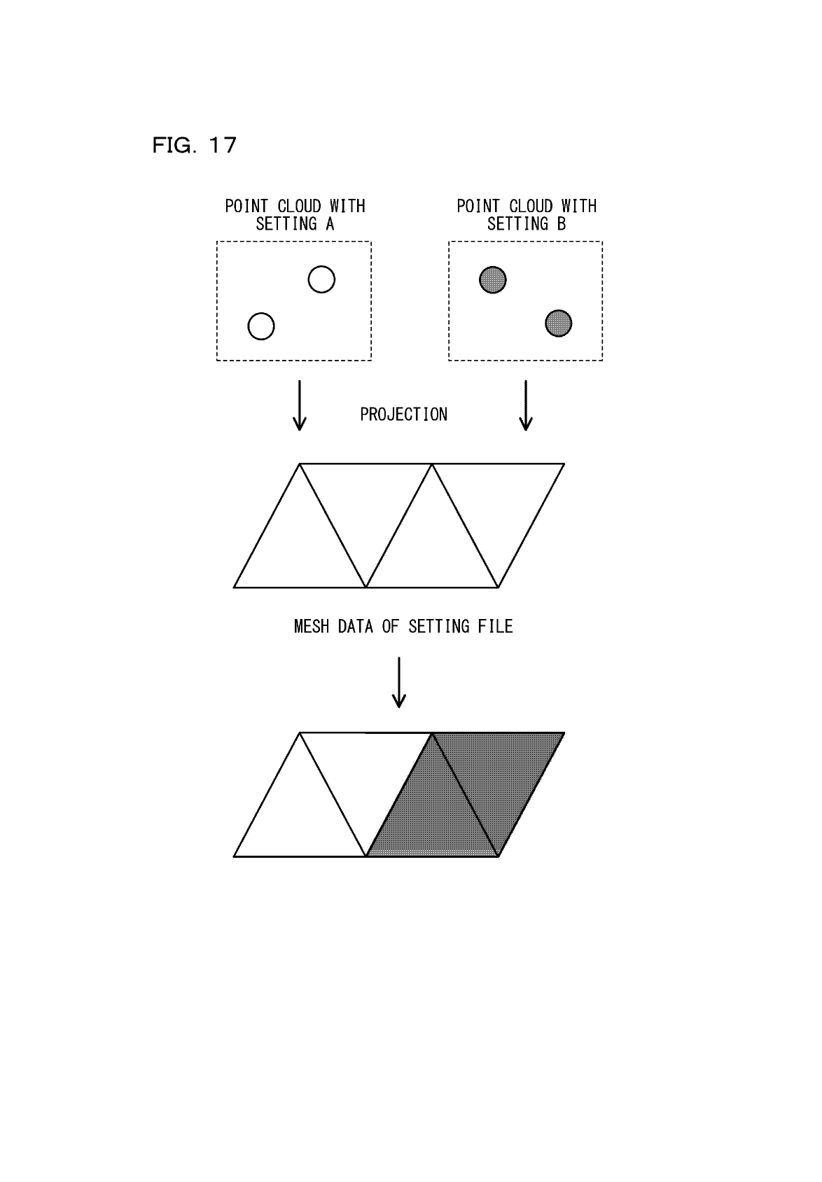

Further, it is also possible to change a color and a display state of mesh data indicating the three-dimensional shape of the reference workpiece in a setting at the time of scanning to present to the user which setting is preferable for scanning. For example, as illustrated in a flowchart of FIG. 16 and a conceptual view of FIG. 17, a setting at the time of scanning may be presented using not only information of the mesh data but also information of a point cloud at the time of scanning. That is, the mesh data and the point cloud are individually stored in Step SB1, and thus, the mesh data and the point cloud are individually read, and the same alignment is performed for the both. In Step SB2, the point cloud and the mesh are associated with each other. In this example, the point cloud is projected onto the mesh based on information regarding position coordinates and the normal line of the point cloud. In Step SB3, a display color of the mesh data is changed according to a setting of the projected point cloud (Setting A and Setting B illustrated in FIG. 17).

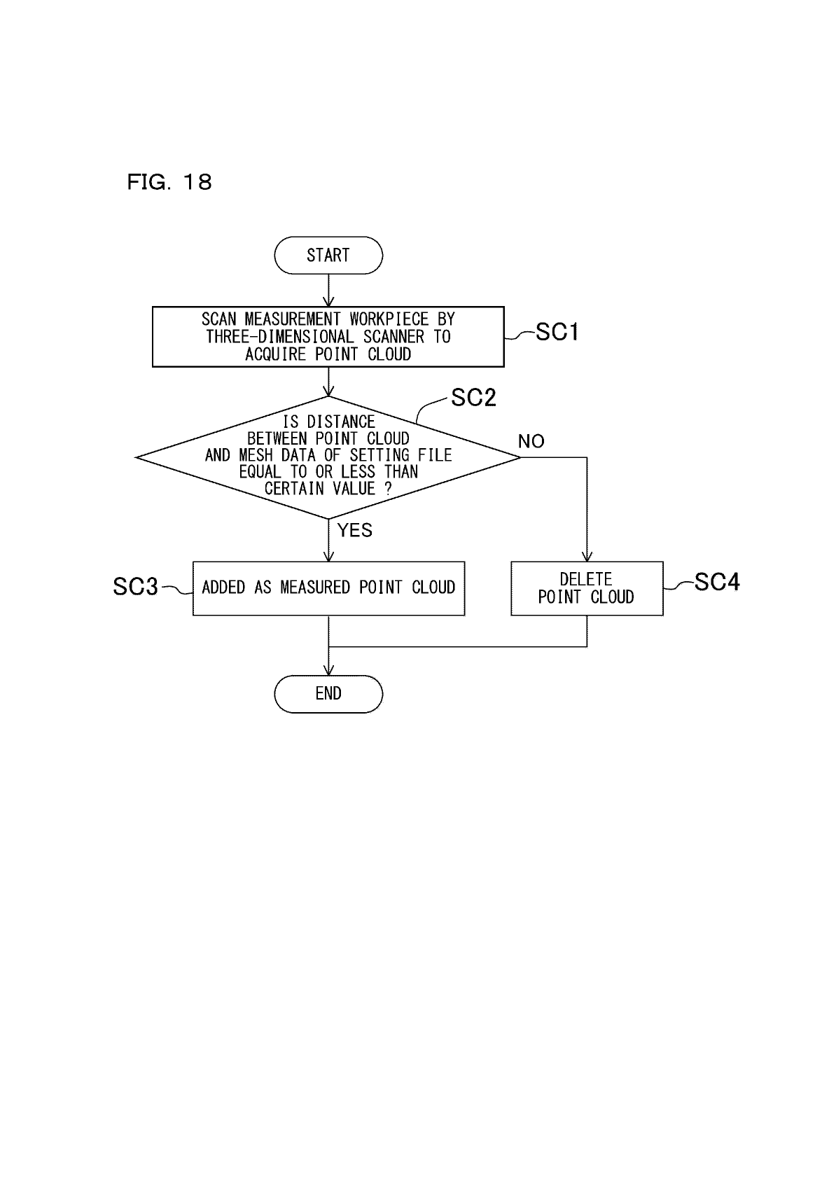

Further, the progress of scanning by the three-dimensional scanner 2 may be presented to the user by comparison with the mesh data of a setting file, or the operation may be automatically performed. In Step SC1 of a flowchart illustrated in FIG. 18, the user scans a measurement workpiece with the three-dimensional scanner 2 to acquire a point cloud. In Step SC2, the control part 43 determines whether a distance between the acquired point cloud and the mesh data of the setting file is equal to or less than a certain value. When the distance between the acquired point cloud and the mesh data of the setting file is equal to or less than the certain value, the processing proceeds to Step SC3, and the point cloud is added as the point cloud measured in Step SC1. When the distance between the acquired point cloud and the mesh data of the setting file is not equal to or less than the certain value, the processing proceeds to Step SC4, and the point cloud measured in Step SC1 is deleted. At this time, a numerical value indicating a percentage of the mesh data of the setting file scanned by the three-dimensional scanner 2 is presented to the user. In a case where the mesh data of the setting file can be scanned by the three-dimensional scanner 2 at a certain ratio or more, the control part 43 may automatically stop scanning. Further, in the case of deleting the point cloud, the point cloud may be deleted in real time during scanning by the three-dimensional scanner 2 instead of deleting mesh data of the measurement workpiece distant from the mesh data of the setting file after scanning.

As described above, the invention can be used in the case of measuring three-dimensional shapes of various workpieces.

What is claimed is:

1. A three-dimensional measurement device that measures a three-dimensional shape of a workpiece, the three-dimensional measurement device comprising:
a three-dimensional scanner including a scanner light source that emits pattern light, and a scanner imaging part that captures the pattern light emitted by the scanner light source and generates an image including the pattern light;
a three-dimensional coordinate generation unit that sequentially generates three-dimensional coordinates of a reference workpiece based on the image including the pattern light generated by the scanner imaging part;
a three-dimensional data generation unit that generates reference three-dimensional shape data of the reference workpiece based on the three-dimensional coordinates sequentially generated by the three-dimensional coordinate generation unit;
a display control part that generates display data for causing a display unit to display the reference three-dimensional shape data generated by the three-dimensional data generation unit;
a setting unit that sets a measurement element for the reference three-dimensional shape data generated by the three-dimensional data generation unit and displayed on the display unit; a measurement unit that performs measurement based on the measurement element set by the setting unit;
a storage unit that stores, as measurement reproduction templates, setting files each of which is obtained by linking the reference three-dimensional shape data generated by the three-dimensional data generation unit to the measurement element set by the setting unit;
a reception unit that receives selection of one template from among the measurement reproduction templates stored in the storage unit;
a reading unit that reads the reference three-dimensional shape data and the measurement element included in the one template received by the reception unit; and
a registration unit that registers the reference three-dimensional shape data and the measurement element, which are read by the reading unit, as referred three-dimensional shape data and a referred measurement element,
wherein the three-dimensional coordinate generation unit sequentially generates three-dimensional coordinates of a measurement workpiece based on the image including the pattern light generated by the scanner imaging part, the display control part sequentially generates display data in which the three-dimensional coordinates of the measurement workpiece sequentially generated by the three-dimensional coordinate generation unit are superimposed on a three-dimensional shape based on the referred three-dimensional shape data registered by the registration unit, the three-dimensional data generation unit generates three-dimensional shape data of the measurement workpiece based on the three-dimensional coordinates of the measurement workpiece, and
the measurement unit performs measurement based on the referred measurement element registered by the registration unit and the three-dimensional shape data of the measurement workpiece.

2. The three-dimensional measurement device according to claim 1, further comprising a data editing unit that partially removes three-dimensional shape data from the reference three-dimensional shape data generated by the three-dimensional data generation unit.

3. The three-dimensional measurement device according to claim 2, wherein the data editing unit partially removes three-dimensional shape data from the three-dimensional shape data of the measurement workpiece based on a distance between the referred three-dimensional shape data registered by the registration unit and the three-dimensional shape data of the measurement workpiece.

4. The three-dimensional measurement device according to claim 1, further comprising:
a contact-type probe that indicates a position of a measurement point; and
a coordinate system generation unit that generates a coordinate system based on positions of a plurality of the measurement points indicated by the contact-type probe,
wherein the coordinate system generation unit generates a reference workpiece coordinate system based on the plurality of measurement points indicated on the reference workpiece by the contact-type probe, and generates a measurement workpiece coordinate system based on the plurality of measurement points indicated on the measurement workpiece by the contact-type probe.

5. The three-dimensional measurement device according to claim 4, further comprising:
an alignment unit that aligns the reference workpiece and the measurement workpiece based on the reference workpiece coordinate system and the measurement workpiece coordinate system generated by the coordinate system generation unit; and
a data editing unit that partially removes three-dimensional shape data from the three-dimensional shape data of the measurement workpiece based on a distance between the referred three-dimensional shape data registered by the registration unit and the three-dimensional shape data of the measurement workpiece in a state in which the referred three-dimensional shape data and the three-dimensional shape data of the measurement workpiece are aligned by the alignment unit.

6. The three-dimensional measurement device according to claim 1, wherein the reception unit receives an input of an extraction reference point and selection of a type of a geometric element to be extracted, and
the storage unit stores, as the measurement element, the extraction reference point received by the reception unit, a display posture of the measurement workpiece on the display unit when the extraction reference point is received, and the type of the geometric element.

7. The three-dimensional measurement device according to claim 6, wherein the measurement unit updates a position and a posture of the three-dimensional shape data of the measurement workpiece based on the display posture stored as the measurement element, extracts the geometric element based on the extraction reference point and the type of the geometric element in a state of the updated position and the updated posture, and performs measurement based on the extracted geometric element.

8. The three-dimensional measurement device according to claim 1, further comprising a combining unit that acquires a plurality of three-dimensional coordinates with different parameters and combines the plurality of acquired three-dimensional coordinates to generate one piece of three-dimensional shape data,
wherein the three-dimensional shape data is associated with point clouds respectively acquired with the parameters and mesh data obtained by combining the point clouds acquired with the parameters.

9. The three-dimensional measurement device according to claim 8, wherein the display control part projects the point clouds respectively acquired with the parameters onto the mesh data to display pieces of data respectively acquired by the parameters in an identifiable manner when the referred three-dimensional shape data is displayed.

10. The three-dimensional measurement device according to claim 1, wherein the three-dimensional scanner includes a communication unit and a scanner display unit,
the communication unit sequentially receives the display data in which the three-dimensional coordinates of the measurement workpiece are superimposed on the three-dimensional shape based on the referred three-dimensional shape data, the referred three-dimensional shape data being sequentially generated by the display control part, and
the scanner display unit displays the display data received by the communication unit.

11. A three-dimensional measurement method of measuring a three-dimensional shape of a workpiece, the three-dimensional measurement method comprising:
capturing an image of pattern light emitted by a scanner light source to generate an image including the pattern light;
sequentially generating three-dimensional coordinates of a reference workpiece based on the generated image including the pattern light;
generating reference three-dimensional shape data of the reference workpiece based on the sequentially generated three-dimensional coordinates;
displaying the generated reference three-dimensional shape data on a display unit and setting a measurement element for the reference three-dimensional shape data displayed on the display unit;
storing, as measurement reproduction templates, setting files each of which is obtained by linking the generated reference three-dimensional shape data to the set measurement element;
receiving selection of one template from among the stored measurement reproduction templates;
reading the reference three-dimensional shape data and the measurement element included in the received one template;
registering the read reference three-dimensional shape data and the read measurement element as referred three-dimensional shape data and a referred measurement element;
sequentially generating display data in which sequentially generated three-dimensional coordinates of a measurement workpiece are superimposed on a three-dimensional shape based on the registered referred three-dimensional shape data;
generating three-dimensional shape data of the measurement workpiece based on the three-dimensional coordinates of the measurement workpiece; and
measuring the measurement workpiece based on the registered referred measurement element and the three-dimensional shape data of the measurement workpiece.

12. A storage medium storing a three-dimensional measurement program for causing a computer to execute a three-dimensional measurement method of measuring a three-dimensional shape of a workpiece,
the three-dimensional measurement program causing the computer to execute:
capturing an image of pattern light emitted by a scanner light source to generate an image including the pattern light;
sequentially generating three-dimensional coordinates of a reference workpiece based on the generated image including the pattern light;
generating reference three-dimensional shape data of the reference workpiece based on the sequentially generated three-dimensional coordinates;
displaying the generated reference three-dimensional shape data on a display unit and setting a measurement element for the reference three-dimensional shape data displayed on the display unit;
storing, as measurement reproduction templates, setting files each of which is obtained by linking the generated reference three-dimensional shape data to the set measurement element;
receiving selection of one template from among the stored measurement reproduction templates;
reading the reference three-dimensional shape data and the measurement element included in the received one template;
registering the read reference three-dimensional shape data and the read measurement element as referred three-dimensional shape data and a referred measurement element;
sequentially generating display data in which sequentially generated three-dimensional coordinates of a measurement workpiece are superimposed on a three-dimensional shape based on the registered referred three-dimensional shape data;
generating three-dimensional shape data of the measurement workpiece based on the three-dimensional coordinates of the measurement workpiece; and measuring the measurement workpiece based on the registered referred measurement element and the three-dimensional shape data of the measurement workpiece.
